(19) United States
(12) Patent Application Publication
(10) Pub. No.: US 2026/0357393 A1
(43) Pub. Date: Nov. 12, 2026

(54) NON-ORIENTED ELECTROMAGNETIC STEEL SHEET

(71) Applicant: NIPPON STEEL CORPORATION, Chiyoda-ku, Tokyo (JP)

(72) Inventors: Natsuko SUGIURA, Chiyoda-ku, Tokyo (JP); Ichiro TANAKA, Chiyoda-ku, Tokyo (JP); Tesshu MURAKAWA, Chiyoda-ku, Tokyo (JP); Shun OTA, Chiyoda-ku, Tokyo (JP)

(21) Appl. No.: 19/139,882

(22) PCT Filed: Jan. 9, 2024
(86) PCT No.: PCT/JP2024/000133

§ 371 Date: Jun. 17, 2025

(30) Foreign Application Priority Data
Jan. 10, 2023 (JP) 2023-001935

(51) Int. Cl. C22C 38/06; C22C 38/02

(52) U.S. Cl. CPC C22C 38/06; C22C 38/02

(57) ABSTRACT

A non-oriented electromagnetic steel sheet having a predetermined chemical composition, in which Formulae (3) to (7) are satisfied in observation on a plane in parallel with a steel sheet surface with EBSD, with a total area Sₜₒₜ, an area S₄₁₁ of a {411} oriented grain, an area S₁₀₀ of a {100} oriented grain, an area S_{tyl} of an oriented grain in which a Taylor factor M according to Formula (2) is more than 2.9, a total area Sₜᵣₐ of an oriented grain in which the Taylor factor M is 2.9 or less, an average KAM value K₄₁₁ of a {411} oriented grain, and an average KAM value K_{tyl} of an oriented grain in which the Taylor factor M is more than 2.9:

M=(cosφ×cosλ)⁻¹ (2)

S₄₁₁/S₁₀₀>1.00 (3)

0.20≤S_{tyl}/Sₜₒₜ≤0.85 (4)

0.05≤S₄₁₁/Sₜₒₜ≤0.80 (5)

S₄₁₁/Sₜᵣₐ≥0.50 (6)

K₄₁₁/K_{tyl}≤0.990 (7)

### TECHNICAL FIELD

The present disclosure relates to a non-oriented electromagnetic steel sheet.

### BACKGROUND ART

Non-oriented electromagnetic steel sheets are used in, for example, iron cores of motors, and non-oriented electromagnetic steel sheets are required to be excellent in magnetic characteristics, for example, low in iron loss and high in magnetic flux density in directions parallel to their sheet surfaces.

It is advantageous therefor to control textures of steel sheets so that magnetization easy axes (<100> orientation) of crystals are matched with directions in sheet surfaces. As such texture control, for example, many techniques for control of a {100} orientation, a {110} orientation, a {111} orientation, or the like are disclosed like techniques described in Patent Literature 1 to 5.

Various methods are devised as methods of controlling textures, and in particular, techniques utilizing “strain-induced grain growth” are exemplified among such methods. Since accumulation of {111} orientations having no magnetization easy axes in directions in sheet surfaces in strain-induced grain growth under certain conditions can be suppressed, such methods are effectively used in non-oriented electromagnetic steel sheets. These techniques are disclosed in Patent Literature 6 to 10, and the like.

However, conventional methods can suppress accumulation of {111} orientations, but cause growth of {110}<001> orientations (hereinafter, Goss orientation). Such Goss orientation is excellent than {111} in terms of magnetic characteristics in one direction, but magnetic characteristics on all-direction average are almost not improved. Therefore, conventional methods have the problem of not providing excellent magnetic characteristics on all-direction average.

In order to realize excellent magnetic characteristics on a all-direction average, Patent Literature 11 to 13 disclose a technique of development of a {100} crystal orientation or a {411} crystal method in the component system in which γ→α phase transformation occurs. Such a techniques realizes a fine grain a-phase structure in a hot-rolled sheet by setting a steel composition low in γ→α phase transformation temperature and performing transformation at a low temperature, and utilizes addition of Mn and a γ-stabilized element such as Cu or Ni from the viewpoint of promotion of accumulation of strain by not only a decrease in transformation temperature, but also delaying of recovery and recrystallization. However, Mn is known as a segregation element, and in the case of being increased in amount of addition thereof, is segregated at the sheet thickness center parts of hot-rolled sheets and causes cracking in cold rolling of such hot-rolled sheets.

### CITATION LIST

### Patent Literature

Patent Literature 1: Japanese Patent Application Laid-Open (JP-A) No. 2017-193754
Patent Literature 2: JP-A No. 2011-111658
Patent Literature 3: WO2016/148010
Patent Literature 4: JP-A No. 2018-3049
Patent Literature 5: WO2015/199211
Patent Literature 6: JP-A No. H8-143960
Patent Literature 7: JP-A No. 2002-363713
Patent Literature 8: JP-A No. 2011-162821
Patent Literature 9: JP-A No. 2013-112853
Patent Literature 10: Japanese Patent Publication (JP-B) No. 4029430
Patent Literature 11: WO2021/095846
Patent Literature 12: WO2021/095851
Patent Literature 13: WO2021/095880

### SUMMARY OF INVENTION

### Technical Problem

In view of the above problems, an object of the disclosure is to provide a non-oriented electromagnetic steel sheet in which a steel sheet having a chemical composition in which Mn is suppressed so as not to cause rollability to be problematic and also the contents of elements such as Cu and Ni are optimized has magnetic characteristics of a small in-plane anisotopy and an excellent all-direction average.

### Solution to Problem

The present inventors have made studies about techniques for formation of a preferred texture for a non-oriented electromagnetic steel sheet by use of strain-induced grain growth. In particular, the inventors have focused on a crystal grain of a {411}<uvw> orientation (hereinafter, {411} orientation), which is a crystal grain to be hardly strained at the same level of a crystal grain of a {100}<uvw> orientation (hereinafter, {100} orientation). In other words, a crystal grain of the {411} orientation is allowed to be more present than a crystal grain of the {100} orientation at the stage before the occurrence of strain-induced grain growth, whereby strain-induced grain growth allows a crystal grain of the {411} orientation to encroach on a crystal grain of the {111} orientation and at the same time suppresses development of a crystal grain of the {100} orientation, thereby producing a non-oriented electromagnetic steel sheet of the {411} orientation as a main orientation. It has been found that, in a case in which development of a crystal grain of the {100} orientation is thus sufficiently suppressed and furthermore the {411} orientation is adopted as a main orientation, magnetic characteristics on all-direction average (average in the rolling direction, the width direction, a direction of 45 degrees with respect to the rolling direction, and a direction of 135 degrees with respect to the rolling direction) are improved.

The inventors have also made studies about a method of allowing a crystal grain of the {411} orientation to be more present than a crystal grain of the {100} orientation at the stage at the stage before the occurrence of strain-induced grain growth. As a result, the inventors have found a method in which steel lower in content of Mn, Ni, Cu, or the like is subjected to hot rolling, furthermore cold rolling and annealing, and then cold rolling again at a lower rolling reduction (skin pass rolling) and thereafter final annealing.

The inventors have further made intensive studies based on these findings, and as a result, have conceived various aspects disclosed below.

(1) A non-oriented electromagnetic steel sheet according to one aspect of the disclosure includes,
by % by mass,
C: 0.0100% or less,
Si: from 1.50% to 4.00%,
sol.Al: from 0.0001% to 1.0%,
S: 0.0100% or less,
N: 0.0100% or less,
Mn: 0.10% or more,
one kind or a plurality of kinds selected from Mn, Ni, or Cu: less than 2.50% in total,
Mo: from 0.0% to less than 2.5%,
Cr: from 0.0% to less than 2.5%,
Ti: from 0.000% to 0.005%,
Nb: from 0.000% to 0.005%,
Sn: from 0.000% to 0.400%,
Sb: from 0.000% to 0.400%,
P: from 0.000% to 0.400%, and
one kind or a plurality of kinds selected from the group consisting of Mg, Ca, Sr, Ba, Ce, La, Nd, Pr, Zn, and Cd: from 0.0000% to 0.0100% in total, wherein
the non-oriented electromagnetic steel sheet has a chemical composition in which, in a case in which, by % by mass, a C content is [C], a Mo content is [Mo], a Cr content is [Cr], a Mn content is [Mn], a Ni content is [Ni], a Cu content is [Cu], a Si content is [Si], a sol.Al content is [sol.Al], and a P content is [P], a transformation temperature Ar₃ (°C) defined by the following Formula (1) is from 750 to 1050 °C and the balance is constituted from Fe and impurities, and
the following Formula (3) and Formula (4) to Formula (7) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, a total area of an oriented grain in which the Taylor factor M is 2.9 or less is defined as Sₜᵣₐ, an average KAM value of a {411} oriented grain is defined as K₄₁₁, and an average KAM value of an oriented grain in which the Taylor factor M is more than 2.9 is defined as K_{tyl},

Ar₃ (°C)=1020−325×[C]+33×[Si]+287×[P]+80×[sol.Al]−120×([Mn]+[Mo]+[Cu])−46×([Cr]+[Ni]) (1)

M=(cosφ×cosλ)⁻¹ (2)

S₄₁₁/S₁₀₀>1.00 (3)

0.20≤S_{tyl}/Sₜₒₜ≤0.85 (4)

0.05≤S₄₁₁/Sₜₒₜ≤0.80 (5)

S₄₁₁/Sₜᵣₐ≥0.50 (6)

K₄₁₁/K_{tyl}≤0.990 (7)
wherein, in Formula (2), φ represents an angle between a stress vector and a slip direction vector of a crystal and λ represents an angle between a stress vector and a normal vector of a crystal slip plane.
   (2) A non-oriented electromagnetic steel sheet according to one aspect of the disclosure includes,
by % by mass,
C: 0.0100% or less,
Si: from 1.50% to 4.00%,
sol.Al: from 0.0001% to 1.0%,
S: 0.0100% or less,
N: 0.0100% or less,
Mn: 0.10% or more,
one kind or a plurality of kinds selected from Mn, Ni, Co, Pt, Pb, Au, or Cu: less than 2.50% in total,
Mo: from 0.0% to less than 2.5%,
Cr: from 0.0% to less than 2.5%,
Ti: from 0.000% to 0.005%,
Nb: from 0.000% to 0.005%,
Sn: from 0.000% to 0.400%,
Sb: from 0.000% to 0.400%,
P: from 0.000% to 0.400%, and
one kind or a plurality of kinds selected from the group consisting of Mg, Ca, Sr, Ba, Ce, La, Nd, Pr, Zn, and Cd: from 0.0000% to 0.0100% in total, wherein
the non-oriented electromagnetic steel sheet has a chemical composition in which, in a case in which, by % by mass, a C content is [C], a Mo content is [Mo], a Cr content is [Cr], a Mn content is [Mn], a Ni content is [Ni], a Cu content is [Cu], a Si content is [Si], a sol.Al content is [sol.Al], and a P content is [P], a transformation temperature Ar₃ (°C) defined by the following Formula (1) is from 750 to 1050 °C and the balance is constituted from Fe and impurities, and
the following Formula (3) and Formula (4) to Formula (7) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, a total area of an oriented grain in which the Taylor factor M is 2.9 or less is defined as Sₜᵣₐ, an average KAM value of a {411} oriented grain is defined as K₄₁₁, and an average KAM value of an oriented grain in which the Taylor factor M is more than 2.9 is defined as K_{tyl},

Ar₃ (°C)=1020−325×[C]+33×[Si]+287×[P]+80×[sol.Al]−120×([Mn]+[Mo]+[Cu])−46×([Cr]+[Ni]) (1)

M=(cosφ×cosλ)⁻¹ (2)

S₄₁₁/S₁₀₀>1.00 (3)

0.20≤S_{tyl}/Sₜₒₜ≤0.85 (4)

0.05≤S₄₁₁/Sₜₒₜ≤0.80 (5)

S₄₁₁/Sₜᵣₐ≥0.50 (6)

K₄₁₁/K_{tyl}≤0.990 (7)
wherein, in Formula (2), φ represents an angle between a stress vector and a slip direction vector of a crystal and λ represents an angle between a stress vector and a normal vector of a crystal slip plane.
   (3) A non-oriented electromagnetic steel sheet according to one aspect of the disclosure includes, by % by mass,
C: 0.0100% or less,
Si: from 1.50% to 4.00%,
sol.Al: from 0.0001% to 1.0%,
S: 0.0100% or less,
N: 0.0100% or less,
Mn: 0.10% or more,
one kind or a plurality of kinds selected from Mn, Ni, or Cu: less than 2.50% in total,
Mo: from 0.0% to less than 2.5%,
Cr: from 0.0% to less than 2.5%,
Ti: from 0.000% to 0.005%,
Nb: from 0.000% to 0.005%,
Sn: from 0.000% to 0.400%,
Sb: from 0.000% to 0.400%,
P: from 0.000% to 0.400%, and
one kind or a plurality of kinds selected from the group consisting of Mg, Ca, Sr, Ba, Ce, La, Nd, Pr, Zn, and Cd: from 0.0000% to 0.0100% in total, wherein
the non-oriented electromagnetic steel sheet has a chemical composition in which, in a case in which, by % by mass, a C content is [C], a Mo content is [Mo], a Cr content is [Cr], a Mn content is [Mn], a Ni content is [Ni], a Cu content is [Cu], a Si content is [Si], a sol.Al content is [sol.Al], and a P content is [P], a transformation temperature Ar₃ (°C) defined by the following Formula (1) is from 750 to 1050 °C and the balance is constituted from Fe and impurities, and
the following Formula (8) to Formula (11) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, and a total area of an oriented grain in which the Taylor factor M is 2.9 or less is defined as Sₜᵣₐ,

Ar₃ (°C)=1020−325×[C]+33×[Si]+287×[P]+80×[sol.Al]−120×([Mn]+[Mo]+[Cu])−46×([Cr]+[Ni]) (1)

M=(cosφ×cosλ)⁻¹ (2)

S₄₁₁/S₁₀₀>2.00 (8)

S_{tyl}/Sₜₒₜ<0.55 (9)

S₄₁₁/Sₜₒₜ>0.30 (10)

S₄₁₁/Sₜᵣₐ≥0.60 (11)
wherein, in Formula (2), φ represents an angle between a stress vector and a slip direction vector of a crystal and λ represents an angle between a stress vector and a normal vector of a crystal slip plane.
   (4) A non-oriented electromagnetic steel sheet according to one aspect of the disclosure includes,
by % by mass,
C: 0.0100% or less,
Si: from 1.50% to 4.00%,
sol.Al: from 0.0001% to 1.0%,
S: 0.0100% or less,
N: 0.0100% or less,
Mn: 0.10% or more,
one kind or a plurality of kinds selected from Mn, Ni, Co, Pt, Pb, Au, or Cu: less than 2.50% in total,
Mo: from 0.0% to less than 2.5%,
Cr: from 0.0% to less than 2.5%,
Ti: from 0.000% to 0.005%,
Nb: from 0.000% to 0.005%,
Sn: from 0.000% to 0.400%,
Sb: from 0.000% to 0.400%,
P: from 0.000% to 0.400%, and
one kind or a plurality of kinds selected from the group consisting of Mg, Ca, Sr, Ba, Ce, La, Nd, Pr, Zn, and Cd: from 0.0000% to 0.0100% in total, wherein
the non-oriented electromagnetic steel sheet has a chemical composition in which, in a case in which, by % by mass, a C content is [C], a Mo content is [Mo], a Cr content is [Cr], a Mn content is [Mn], a Ni content is [Ni], a Cu content is [Cu], a Si content is [Si], a sol.Al content is [sol.Al], and a P content is [P], a transformation temperature Ar₃ (°C) defined by the following Formula (1) is from 750 to 1050 °C and the balance is constituted from Fe and impurities, and
the following Formula (8) to Formula (11) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, and a total area of an oriented grain in which the Taylor factor M is 2.9 or less is defined as Sₜᵣₐ,

Ar₃ (°C)=1020−325×[C]+33×[Si]+287×[P]+80×[sol.Al]−120×([Mn]+[Mo]+[Cu])−46×([Cr]+[Ni]) (1)

M=(cosφ×cosλ)⁻¹ (2)

S₄₁₁/S₁₀₀>2.00 (8)

S_{tyl}/Sₜₒₜ<0.55 (9)

S₄₁₁/Sₜₒₜ>0.30 (10)

S₄₁₁/Sₜᵣₐ≥0.60 (11)
wherein, in Formula (2), φ represents an angle between a stress vector and a slip direction vector of a crystal and λ represents an angle between a stress vector and a normal vector of a crystal slip plane.

### Advantageous Effect of Invention

The above aspects of the disclosure can provide a non-oriented electromagnetic steel sheet in which a steel sheet having a chemical composition in which Mn is suppressed so as not to cause rollability to be problematic and also the contents of elements such as Cu and Ni are optimized has magnetic characteristics of a small in-plane anisotopy and an excellent all-direction average.

### DESCRIPTION OF EMBODIMENTS

The non-oriented electromagnetic steel sheet according to the embodiment is produced by subjecting a steel material having a chemical composition described below, to a hot rolling step, a cold rolling step, an intermediate annealing step, and a skin pass rolling step.

A non-oriented electromagnetic steel sheet according to another embodiment of the disclosure is produced by subjecting a steel material having a chemical composition described below, to a cold rolling step, an intermediate annealing step, a skin pass rolling step, and a final annealing step.

In the non-oriented electromagnetic steel sheet according to the embodiment, the amount of Mn added is reduced, to ensure rollability, and furthermore component adjustment is performed and also hot rolling conditions are optimized, to form an appropriate α-processed grain structure in a hot-rolled sheet, thereby developing a {411} oriented grain in subsequent cold rolling and intermediate annealing. A {411} oriented grain is allowed to be more present than a {100} oriented grain at the stage before the occurrence of strain-induced grain growth, whereby strain-induced grain growth allows a {411} oriented grain to mainly encroach on a {111} oriented grain and at the same time suppresses development of a {100} oriented grain, thereby producing a non-oriented electromagnetic steel sheet of the {411} orientation as a main orientation.

The steel sheet undergoes strain-induced grain growth and/or normal grain growth by final annealing after skin pass rolling.

It is then effective for a decrease in-plane anisotopy of magnetic characteristics and an improvement in all-direction average of magnetic characteristics to sufficiently suppress development of a {100} orientation and furthermore enrich a {411} oriented grain.

The steel sheet after skin pass rolling can serve as an original sheet of the steel sheet after strain-induced grain growth and normal grain growth. Hereinafter, the steel sheet after skin pass rolling and the steel sheet after strain-induced grain growth and normal grain growth are each described as the non-oriented electromagnetic steel sheet, regardless of before or after final annealing.

In the non-oriented electromagnetic steel sheet according to the embodiment, a crystal grain mainly of a {411} orientation (hereinafter, {411} oriented grain) is more present than a {100} oriented grain in a metal structure of the steel sheet before skin pass rolling, whereby the {411} oriented grain is more increased during subsequent skin pass rolling and final annealing and magnetic characteristics of the entire periphery are enhanced. The {411} oriented grain may also be increased before skin pass rolling, by any other than the above process.

First, the chemical composition of an oriented electromagnetic steel sheet which is a material used in the non-oriented electromagnetic steel sheet according to the embodiment and the production method thereof is described. The chemical composition is not changed by rolling or a heat treatment, and therefore the chemical composition of an oriented electromagnetic steel sheet serving as the material is the same as the chemical composition of a non-oriented steel sheet through each step. In the following description, the expression “%” as the unit of the content of each element included in the non-oriented electromagnetic steel sheet or the steel material means “% by mass”, unless particularly noted.

Herein, a numerical value range expressed with “(from) . . . to . . . ” means a range including numerical values described before and after “to” as the lower limit value and the upper limit value. It is also obvious that each element in embodiments below can be combined.

The “non-oriented electromagnetic steel sheet” in embodiments of the disclosure encompasses not only a coil-shaped or cut sheet-shaped steel sheet, but also a steel sheet processed as a material for a product (member) such as a motor core, into a specified shape, and furthermore a steel sheet that is processed and then layered, to form a motor core.

First, chemical compositions of a non-oriented electromagnetic steel sheet according to an embodiment of the disclosure and a steel material used in the production method of the steel sheet are described. In the following description, the expression “%” as the unit of the content of each element included in the non-oriented electromagnetic steel sheet or the steel material means “% by mass”, unless particularly noted. The chemical composition of the non-oriented electromagnetic steel sheet indicates the content under the assumption that a base material excluding a film and the like is 100%.

The upper limit value in a certain numerical value range described stepwise, as a numerical value range described stepwise herein, may be replaced with the upper limit value in any other numerical value range described stepwise, or may be replaced with a value shown in Examples.

The lower limit value in a certain numerical value range described stepwise, as a numerical value range described stepwise herein, may be replaced with the lower limit value in any other numerical value range described stepwise, or may be replaced with a value shown in Examples.

The non-oriented electromagnetic steel sheet according to the embodiment has a chemical composition capable of allowing for the occurrence of ferrite-austenite transformation (hereinafter, α-γ transformation), the chemical composition containing
by % by mass,
C: 0.0100% or less,
Si: from 1.50% to 4.00%,
sol.Al: from 0.0001% to 1.0%,
S: 0.0100% or less,
N: 0.0100% or less,
Mn: 0.10% or more,
one kind or a plurality of kinds selected from Mn, Ni, or Cu: less than 2.50% in total,
Mo: from 0.0% to less than 2.5%
Cr: from 0.0% to less than 2.5%
Ti: from 0.000% to 0.005%
Nb: from 0.000% to 0.005%
Sn: from 0.000% to 0.400%,
Sb: from 0.000% to 0.400%,
P: from 0.000% to 0.400%, and
one kind or a plurality of kinds selected from the group consisting of Mg, Ca, Sr, Ba, Ce, La, Nd, Pr, Zn, and Cd: from 0.0000% to 0.0100% in total, in which the contents of C, Si, P, sol.Al, Mn, Mo, Cu, Cr and Ni satisfy predetermined conditions described below and the balance is constituted from Fe and impurities.

The non-oriented electromagnetic steel sheet according to the embodiment preferably contains less than 2.50% in total of one kind or a plurality of kinds selected from Mn, Ni, Co, Pt, Pb, Au, or Cu.

Examples of such impurities include those included in a raw material such as ore or scrap, or those included during a production process.

### (C: 0.0100% or Less)

C increases iron loss and/or causes magnetic aging. Accordingly, a lower C content is more preferred. Such a phenomenon is remarkably caused at a C content of more than 0.0100%. Therefore, the C content is set to 0.0100% or less. A reduction in C content also contributes to uniform enhancements in magnetic characteristics in all directions in the sheet surface. The lower limit of the C content is not particularly limited, and is preferably 0.0005% or more in consideration of the cost of a decarburization treatment during refining.

### (Si: From 1.50% to 4.00%)

Si increases the electric resistance, thereby resulting in a decrease in eddy-current loss and a reduction in iron loss, and increases the yield ratio, thereby resulting in an enhancement in punching processability to an iron core. A Si content of less than 1.50% cannot sufficiently provide such effects. Accordingly, the Si content is set to 1.50% or more. In this regard, a Si content of more than 4.00% causes a decrease in magnetic flux density, and an excess increase in hardness and thus a decrease in punching processability, and makes cold rolling difficult. Accordingly, the Si content is set to 4.00% or less.

### (Sol.Al: From 0.0001% to 1.0%)

Sol.Al increases the electric resistance, thereby resulting in a decrease in eddy-current loss and a reduction in iron loss. Sol.Al also contributes to an enhancement in relative magnitude of the magnetic flux density B₅₀ to the saturated magnetic flux density. A sol.Al content of less than 0.0001% cannot sufficiently provide such effects. Al has also a desulfurization promotion effect in steelmaking. Accordingly, the sol.Al content is set to 0.0001% or more. In this regard, a sol. Al content of more than 1.0% leads to a decrease in magnetic flux density or a decrease in yield ratio, resulting in a decrease in punching processability. Accordingly, the sol. Al content is set to 1.0% or less.

Herein, sol. Al means acid-soluble Al which is not in the form of an oxide such as Al₂O₃ and which is soluble in an acid.

The magnetic flux density B₅₀ here means a magnetic flux density in a magnetic field at 5000 A/m.

### (S: 0.0100% or Less)

S is not an essential element, and for example, is contained as an impurity in steel. S is in the form of a precipitate of fine MnS, and inhibits recrystallization and crystal grain growth in annealing. Accordingly, a lower S content is more preferred. Such increase in iron loss and decrease in magnetic flux density due to inhibition of recrystallization and crystal grain growth remarkably occur at a S content of more than 0.0100%. Thus, the S content is set to 0.0100% or less. The lower limit of the S content is not particularly limited, and is preferably set to 0.0003% or more in consideration of the cost of a desulfurization treatment in refining.

(N: 0.0100% or less)

N degrades magnetic characteristics as in C, and therefore a lower N content is more preferred. Accordingly, the N content is set to 0.0100% or less. The lower limit of the N content is not particularly limited, and is preferably 0.0010% or more in consideration of the cost of a denitrification treatment in refining.

(One Kind or Plurality of Kinds Selected from Mn, Ni, or Cu: Less than 2.50% in Total)

In a case in which 2.5% or more in total of Mn, Ni, and Cu are contained, anisotropy in magnetic characteristics is increased and therefore the total of Mn, Ni, and Cu is set to less than 2.5%. The reason for an increase in anisotropy, although not clear, is considered because slip deformation in a ferrite region is affected and formation of the {100} orientation and recrystallization are promoted. The content of an alloy element is preferably increased by 2.3% or less from this viewpoint. The lower limit value of the total of Mn, Ni, and Cu is not particularly limited, and, for example, may be set to 0.10% or more, may be set to 0.50% or more, or 1.00% or more, or furthermore may also be set to 2.00% or more.

(One Kind or Plurality of Kinds Selected from Mn, Ni, Co, Pt, Pb, Au, or Cu: Less than 2.50% in Total)

In addition to Mn, Ni, and Cu described above, Co, Pt, Pb, and Au also increase anisotropy in magnetic characteristics, and therefore the total content of these elements is preferably less than 2.50% in the embodiment. These elements also lead to a decrease in magnetic flux density, and therefore the total thereof is preferably set to less than 2.00%. The lower limit of the total of Mn, Ni, Co, Pt, Pb, Au, and Cu is not particularly limited, and, for example, may be set to 0.10% or more, may be set to 0.50% or more, or 1.00% or more, or furthermore may also be set to 2.00% or more. In particular, Co, Pt, Pb, and Au are expensive in terms of the alloy cost and thus are to be avoided from being actively added. Also in consideration of control of the Ar₃ transformation point as one feature of the embodiment, the Ar₃ transformation point is preferably controlled by inclusion of Mn, Ni, and Cu. Therefore, the total of Co, Pt, Pb, and Au is less than 0.5%, still more preferably 0.1% or less, and furthermore these elements are suppressed within inevitable elements incorporated and are not needed to be actively added (the total may also be set to 0%).

The non-oriented electromagnetic steel sheet and the steel material according to the embodiment further satisfy the following conditions as conditions in which α-γ transformation can occur. In other words, in a case in which, by % by mass, the C content is [C], the Mo content is [Mo], the Cr content is [Cr], the Mn content is [Mn], the Ni content is [Ni], the Cu content is [Cu], the Si content is [Si], the sol. Al content is [sol. Al], and the P content is [P], the transformation temperature Ar₃ (° °C) defined by the following Formula (1) satisfies from 750 to 1050 °C.

Ar₃ (°C)=1020−325×[C]+33×[Si]+287×[P]+80×[sol.Al]−120×([Mn]+[Mo]+[Cu])−46×([Cr]+[Ni]) (1)

In a case in which the above Formula (1) is not satisfied, the transformation point is not in an appropriate temperature range even in the case of the occurrence of α-γ transformation and therefore a sufficient magnetic flux density cannot be obtained even by application of a production method described below. An Ar₃ transformation point of less than 750 °C lowers the temperature in hot rolling, thereby resulting in not only an increase in deformation resistance and a too large load on a rolling machine, but also an increase in amount of an element added, thereby causing a hot-rolled sheet and a cold-rolled sheet to be decreased in toughness, and therefore this value is defined as the lower limit. In this regard, an Ars transformation point of more than 1050 °C excessively increases the temperature in hot rolling, thereby resulting in a need for heating at an extremely high temperature and thus an increase load on a heating furnace, or resulting in a component system in which γ→α transformation does not occur, and therefore this value is defined as the upper limit.

### (Mn: 0.10% or More)

Mn lowers the Ar₃ transformation point and can allow for refinement of a crystal grain in a hot-rolled sheet due to phase transformation in a component system of the non-oriented electromagnetic steel sheet according to the embodiment. Mn is an element which increases the electric resistance of steel and reduces iron loss. Therefore, 0.1% or more of Mn is contained. From this viewpoint, more preferably 0.5% or more, still more preferably 1.0% or more of Mn is contained. In this regard, Mn is an element which is easily segregated, and in the case of being increased in content, not only causes cracking in cold-processing, due to segregation, but also decreases the saturated magnetic flux density and prevents the steel sheet from being increased in magnetic flux density. MnS is also excessively produced, thereby resulting in a decrease in cold processability. Therefore, the upper limit of the Mn content is set to less than 2.5%. The upper limit of the Mn content is preferably 2.3% by mass or less, more preferably 2.0% by mass.

(Cu: Less than 2.5% in Total of Cu and Elements Described Above)

Cu is an element which allows the steel sheet to be increased in electric resistance and reduced in iron loss as in Mn, and is an element which lowers the Ar₃ transformation point to allow for refinement of the grain size in a hot-rolled sheet due to phase transformation in the chemical composition of the non-oriented electromagnetic steel sheet according to the embodiment. However, an increased Cu content not only has an adverse effect on texture formation in annealing after cold rolling, due to an increase in recrystallization temperature, and also causes hot embrittlement, but also decreases the saturated magnetic flux density and prevents an increase in magnetic flux density of the steel sheet, and therefore requires attention. Herein, hot embrittlement due to Cu can be alleviated by composite addition of Ni in an amount equal to or more than ½ of the Cu content. The upper limit of the Cu content is not limited, and is set to less than 2.5%. The upper limit of the Cu content is preferably 1.5% by mass or less, more preferably 1.0% by mass or less. The lower limit of the Cu content is not particularly limited, and may be set to, for example, 0.01% or more.

(Ni: less than 2.5% in Total of Ni and Elements Described above)

Ni allows the steel sheet to be increased in electric resistance and reduced in iron loss as in Mn. Furthermore, Ni can lower the A₃ transformation point, to allow for refinement of the crystal grain due to phase transformation in the chemical composition of the non-oriented electromagnetic steel sheet according to the embodiment. However, a too high Ni content not only increases the product cost due to Ni which is expensive, but also decreases the saturated magnetic flux density and prevents the steel sheet from being increased in magnetic flux density, and therefore these are preferably considered in design of the content. The upper limit of the Ni content is not limited, and is set to less than 2.5%. The upper limit of the Ni content is preferably 1.0% by mass or less, more preferably 0.7% by mass or less. The lower limit of the Ni content is not particularly limited, and may be, for example, 0.01% or more.

(Mo: From 0.0% to Less than 2.5%)

Mo is an element which can lower the Ar₃ transformation point, to allow for refinement of the grain size in a hot-rolled sheet due to phase transformation, in the chemical composition of the non-oriented electromagnetic steel sheet according to the embodiment. Accordingly, Mo may be, if necessary, contained, and is preferably contained at 0.1% or more. In this regard, Mo contained at 2.5% or more remarkably decreases cold processability, whereby the Mo content is set to less than 2.5%.

(Cr: From 0.0% to Less than 2.5%)

Cr not only is an element which can lower the Ars transformation point, to allow for refinement of the grain size in a hot-rolled sheet due to phase transformation, in the chemical composition of the non-oriented electromagnetic steel sheet according to the embodiment, but also has the effect of not only intensity adjustment, but also enhancements in high-frequency characteristics, in addition to corrosion resistance. Accordingly, Cr may be, if necessary, contained, and is preferably contained at 0.1% or more. In this regard, Cr excessively contained not only causes the effect to be saturated, thereby resulting in an increase in raw material cost, but also decreases the saturated magnetic flux density, thereby preventing the steel sheet from being increased in magnetic flux density. Therefore, the Cr content is set to less than 2.5%.

### (Ti: From 0.000% to 0.005%)

Ti is present as a solid solution or TiN, thereby allowing recrystallization to be suppressed and contributing to refinement of the austenite grain size. Accordingly, Ti may be, if necessary, contained, and is preferably contained at 0.001% or more. In this regard, a Ti content of more than 0.005% causes production of various precipitates such as TiN, TiS, and TiC, and degrades iron loss characteristics, whereby the Ti content is set to 0.005% or less.

### (Nb: From 0.000% to 0.005%)

Nb is present as a solid solution or NbN, thereby allowing recrystallization to be suppressed and contributing to refinement of the austenite grain size. Accordingly, Nb may be, if necessary, contained, and is preferably contained at 0.001% or more. In this regard, a Nb content of more than 0.005% causes production of various precipitates such as NbN and NbC and degrades iron loss characteristics, whereby the Nb content is set to 0.005% or less.

### (Sn: From 0.000% to 0.400%, Sb: From 0.000% to 0.400%, P: From 0.000% to 0.400%)

Sn and Sb improve a texture after cold rolling and recrystallization and enhance the magnetic flux density. Therefore, these elements may be, if necessary, contained, but may be excessively included to cause embrittlement of steel. Accordingly, the Sn content and the Sb content are each set to 0.400% or less. P may be contained in order to ensure the hardness of the steel sheet after recrystallization, but may be excessively included to cause embrittlement of steel. Accordingly, the P content is set to 0.400% or less.

In a case in which further effects such as magnetic characteristics are imparted, one kind or a plurality of kinds selected from the group consisting of 0.020% to 0.400% of Sn, 0.020% to 0.400% of Sb, and 0.020% to 0.400% of P is preferably contained.

(One Kind or Plurality of Kinds Selected from the Group Consisting of Mg, Ca, Sr, Ba, Ce, La, Nd, Pr, Zn, and Cd: From 0.0000% to 0.0100% in Total)

Mg, Ca, Sr, Ba, Ce, La, Nd, Pr, Zn, and Cd are reacted with S in molten steel during casting of the molten steel, to produce a precipitate of sulfide or oxysulfide, or both thereof. Hereinafter, Mg, Ca, Sr, Ba, Ce, La, Nd, Pr, Zn, and Cd may be collectively referred to as “coarse precipitate-production element”. The grain size of a precipitate of the coarse precipitate-production element is from about 1 μm to 2 μm, and is much larger than the grain size (about 100 nm) of a fine precipitate of MnS, TiN, AlN, TiC, NbC, or the like. Therefore, such a fine precipitate is attached to the precipitate of the coarse precipitate-production element, and hardly inhibits recrystallization and crystal grain growth in annealing such as intermediate annealing. In order to sufficiently obtain these effects, the total of the coarse precipitate-production element is preferably 0.0005% or more. However, in a case in which the total of these elements exceeds 0.0100%, the total amount of sulfide or oxysulfide, or both thereof is excess, and recrystallization and crystal grain growth in annealing such as intermediate annealing are inhibited. Accordingly, the total content of the coarse precipitate-production element is set to 0.0100% or less.

In the embodiment, the balance other than the above in the chemical composition may be Fe and impurities. The impurities mean any steel raw material and/or any element incorporated in the course of steelmaking. Any other element may be further contained instead of some Fe as long as the effects of the invention are not lost. For example, 0.10% or less of each of B, O, V, Bi, W, and Y may be contained. The total of the whole impurities is preferably 5.00% or less, more preferably 1.00% or less.

The chemical composition is determined by the following method.

The chemical composition may be measured by a common analysis method of steel. For example, the chemical composition may be measured with ICP-AES (Inductively Coupled Plasma-Atomic Emission Spectrometry). Specifically, the chemical composition is identified by measurement of a test piece collected from the steel sheet with a predetermined measurement apparatus under conditions based on the calibration made in advance. C and S may be measured with a combustion infrared absorption method, and N may be measured with an inert gas fusion-thermal conductivity method. O may be measured with an inert gas fusion-nondispersive infrared absorption method.

In a case in which an insulation film is present on a surface, the film may be mechanically removed by a minitor or the like and then the resultant may be subjected to analysis.

Next, the thickness of the non-oriented electromagnetic steel sheet according to the embodiment is described. The sheet thickness of the non-oriented electromagnetic steel sheet according to the embodiment is not particularly limited. A preferred sheet thickness of the non-oriented electromagnetic steel sheet according to the embodiment is from 0.10 to 0.50 mm. In general, a thinner sheet thickness leads to less iron loss, but a lower magnetic flux density. In view of this, a sheet thickness of 0.10 mm or more leads to less iron loss and a higher magnetic flux density. A sheet thickness of 0.50 mm or less can allow less iron loss to be kept.

Next, a metal structure of the non-oriented electromagnetic steel sheet according to the embodiment is described. Hereinafter, a non-oriented electromagnetic steel sheet of each embodiment is identified by the metal structure after skin pass rolling and the metal structure after final annealing.

First, the metal structure identified and the identification method thereof are described. The metal structure identified in the embodiment is one identified in a cross section parallel to a sheet surface of the steel sheet, and is identified by the following procedure.

First, a sample is polished to a thickness of ⅞ of the sheet thickness so that a location corresponding to ⅛ of the sheet thickness is exposed, and this polished plane (polished plane obtained by polishing the steel sheet by ⅛ of the steel sheet from a sheet surface) is observed with a SEM at an acceleration voltage of 25 kV and a magnification of 1000×, by EBSD (Electron Back Scattering Diffraction). The field of view observed is a field of 500 μm×500 μm in the case of a sample after skin pass rolling, or a field of 2000 μm×2000 μm in the case of a sample after strain removal annealing. Such observation may also be performed at several locations obtained by division into some small compartments. The step interval during measurement is set to 0.3 μm in the case of a sample after skin pass rolling, or 2.0 μm in the case of a sample after strain removal annealing. The following types of area and KAM (Kernel Average Misorientation) value are each obtained from the observation data of EBSD, by a common method.

The area of each orientation can be determined by calculating IPF (Inverse Pole Figure) from the field of view observed of EBSD. The KAM value can be determined by calculating the difference in orientation between measurement points, by use of software such as OIM Analysis. In the disclosure, the average value with respect to the value obtained by using OIM Analysis 7.3, setting the boundary (tolerance) of inclusion into the KAM value, to a difference in orientation from an adjacent pixel, of 5° or less, and calculating the difference in orientation between most adjacent (1^{st} neighbor) measurement points is used as the KAM value. The “Set zero point kernel to maximum misorientations” is set by leaving the defaults and checking the box thereof.

### Sₜₒₜ: Total Area (Area Observed)

S_{tyl}: total area of oriented grain having a Taylor factor M according to the following Formula (2), of more than 2.9
Sₜᵣₐ: total area of oriented grain having a Taylor factor M according to the following Formula (2), of 2.9 or less
S₄₁₁: total area of {411} oriented grain
S₁₀₀: total area of {100} oriented grain
K_{tyl}: average KAM value of oriented grain having a Taylor factor M according to the following Formula (2), of more than 2.9
K₄₁₁: average KAM value of {411} oriented grain

The orientation tolerance of a crystal plane orientation is set to 10°. Hereinafter, the orientation tolerance is set to 10° also in the description of a certain crystal plane orientation. In other words, a crystal grain having a plane orientation within ±10° from a certain plane orientation described in the disclosure is handled as a crystal grain having this certain crystal orientation.

The Taylor factor M is according to the following Formula (2).

M=(cosφ×cosλ)⁻¹ (2)
φ: angle between stress vector and slip direction vector of crystal
λ: angle between stress vector and normal vector of crystal slip plane

The Taylor factor M means a Taylor factor in a case in which crystal slip deformation is assumed to occur on a slip plane {110} or {112}, or in a slip direction <111> and not deformation in the sheet width direction occurs, but compression deformation toward the sheet thickness direction and expansion deformation toward the rolling direction occur.

The method of determining the Taylor factor by analysis with SEM-EBSD data by OIM Analysis 7.3 is described. The Taylor Factor is selected as an object (Type) in a function which performs Chart creation, of OIM Analysis 7.3. Detailed conditions for determining the Taylor factor are as follows.

Iron (Alpha) is selected as Phase of a slip system, and the following two are input with respect to the slip system.
Slip plane: 101, slip direction: 11-1, CRSS: 0.2
Slip plane: 112, slip direction: 11-1, CRSS: 0.2

As long as the slip plane and the slip direction are selected as a combination so that the inner product is 0, the same result is obtained even in the case of different numerical orders or symbols. The same value is input for two slip systems in the case of CRSS (Critical Resolved Shear Stress).

The following tensors of rolling deformation are input in Deformation Gradient.

RD, TD, ND

| | | | |
|---|---|---|---|
| RD | 1 | 0 | 0 |
| TD | 0 | 0 | 0 |
| ND | 0 | 0 | −1 |

The Taylor factors of all the measurement points are calculated as a histogram under such conditions, and these results can be adopted to conversion into the area ratio of an oriented grain in which the Taylor factor is 2.9 or more or the Taylor factor is less than 2.9.

Next, features in the following embodiments 1 to 2 are prescribed by the above area and KAM value.

### Embodiment 1

First, the metal structure of the non-oriented electromagnetic steel sheet after skin pass rolling is described. The metal structure is one in which sufficient strain is accumulated for the occurrence of strain-induced grain growth, and can be situated in a condition of the initial stage before the occurrence of strain-induced grain growth. Features of the metal structure of the steel sheet after skin pass rolling are prescribed roughly by an orientation for the development of a crystal grain of an objective orientation, and conditions about strain sufficiently accumulated for the occurrence of strain-induced grain growth.

In the non-oriented electromagnetic steel sheet according to Embodiment 1, the area of each oriented grain satisfies the following Formula (3) and Formula (4) to Formula (6).

S₄₁₁/S₁₀₀>1.00 (3)

0.20≤S_{tyl}/Sₜₒₜ≤0.85 (4)

0.05≤S₄₁₁/Sₜₒₜ≤0.80 (5)

S₄₁₁/Sₜᵣₐ≥0.50 (6)

Although the {411} oriented grain is mainly described as the oriented grain to be preferentially grown, any other oriented grains are also much present which are relatively small in Taylor factor as in the {411} oriented grain, which have an orientation hardly allowing for accumulation of strain, and which are oriented grains which can be preferentially grown in strain-induced grain growth. In particular, an orientation easily present in the non-oriented electromagnetic steel sheet is a {100} orientation. This oriented grain competes against the {411} oriented grain to be preferentially grown. In this regard, this oriented grain is disadvantageous because an orientation in a plane of the steel sheet is difficult to randomly control and, in a case in which the {100} orientation is developed by strain-induced grain growth, an in-plane anisotropy of a specified steel sheet is increased. Therefore, Embodiment 1 is prescribed so that the abundance ratio of the {411} oriented grain in an orientation in which the Taylor factor is relatively small and strain by processing is hardly accumulated is ensured. The area ratio S₄₁₁/S₁₀₀ is more than 1.00. In other words, the {411} oriented grain is allowed to be more present than the {100} oriented grain. In a case in which development of the {100} oriented grain is sufficiently suppressed and furthermore the {411} oriented grain is mainly allowed to be present in terms of an orientation, magnetic characteristics on all-direction average (average in the rolling direction, the width direction, a direction of 45 degrees with respect to the rolling direction, and a direction of 135 degrees with respect to the rolling direction) are improved.

The area ratio S₄₁₁/S₁₀₀ is preferably 2.0 or more, and the area ratio S₄₁₁/S₁₀₀ is more preferably 3.0 or more.

The upper limit of the area ratio S₄₁₁/S₁₀₀ does not need to be particularly limited. Even a case in which the {100} oriented grain is not present at all and the value of the area ratio S₄₁₁/S₁₀₀ is infinite is not problematic at all in terms of the objects of the disclosure. However, many loads in terms of production are caused in order to achieve substantially no presence of the {100} oriented grain, and therefore the area ratio S₄₁₁/S₁₀₀ is 20 or less or the area ratio S₄₁₁/S₁₀₀ is more preferably 10 or less.

S_{tyl} means the amount of presence of an orientation in which the Taylor factor is relatively large. In a strain-induced grain growth step, an orientation in which the Taylor factor is small and strain is hardly accumulated is preferentially grown with encroaching on an orientation in which the Taylor factor is large and strain is accumulated. Therefore, S_{tyl} is needed to be at a certain level in order to develop a special orientation by strain-induced grain growth. In Embodiment 1, S_{tyl} is defined as the area ratio S_{tyl}/Sₜₒₜ with respect to the total area, and the area ratio S_{tyl}/Sₜₒₜ is 0.20 or more. In a case in which the area ratio S_{tyl}/Sₜₒₜ is less than 0.20, an objective crystal orientation is not to sufficiently developed by strain-induced grain growth. The area ratio S_{tyl}/Sₜₒₜ is preferably 0.30 or more, more preferably 0.50 or more.

The upper limit of the area ratio S_{tyl}/Sₜₒₜ is associated with the amount of a crystal oriented grain to be developed in a strain-induced grain growth step described below, and conditions are not to be determined simply only by the ratio between an orientation to be preferentially grown and an orientation which is to undergo encroachment. First, as described below, the area ratio S₄₁₁/Sₜₒₜ of the {411} oriented grain to be developed by strain-induced grain growth is 0.05 or more, and therefore the area ratio S_{tyl}/Sₜₒₜ is necessarily 0.95 or less. However, in a case in which the area ratio S_{tyl}/Sₜₒₜ is excess in terms of the amount of presence, preferential growth of the {411} oriented grain does not occur in association with strain described below. While such association with the amount of strain is described below, the area ratio S_{tyl}/Sₜₒₜ is 0.85 or less in Embodiment 1. The area ratio S_{tyl}/Sₜₒₜ is preferably 0.75 or less, more preferably 0.70 or less.

In a strain-induced grain growth step described below, the {411} oriented grain is preferentially grown. The {411} orientation is one orientation in which the Taylor factor is relatively small and strain is hardly accumulated, and is an orientation which can be preferentially grown in such a strain-induced grain growth step. The presence of the {411} oriented grain is essential in Embodiment 1, and the area ratio S₄₁₁/Sₜₒₜ of the {411} oriented grain in Embodiment 1 is set to 0.05 or more. In a case in which the area ratio S₄₁₁/Sₜₒₜ of the {411} oriented grain is less than 0.05, the {411} oriented grain is sufficiently developed by subsequent strain-induced grain growth. The area ratio S₄₁₁/Sₜₒₜ is preferably 0.10 or more, more preferably 0.20 or more.

The upper limit of the area ratio S₄₁₁/Sₜₒₜ is determined depending on the amount of presence of a crystal oriented grain to be subjected to encroachment in strain-induced grain growth. In Embodiment 1, the area ratio S_{tyl}/Sₜₒₜ in an orientation in which the Taylor factor is more than 2.9, which is to undergo encroachment in strain-induced grain growth, is 0.20 or more, and therefore the area ratio S₄₁₁/Sₜₒₜ is 0.80 or less. It is noted that a smaller amount of presence of the {411} oriented grain before strain-induced grain growth leads to more remarkable predominance of grain growth and also allows for more development of the {411} oriented grain. In consideration of this, the area ratio S₄₁₁/Sₜₒₜ is preferably 0.60 or less, more preferably 0.50 or less, still more preferably 0.40 or less.

Although the {411} oriented grain is mainly described as the oriented grain to be preferentially grown, any other oriented grains are present which are relatively small in Taylor factor as in the {411} oriented grain, which have an orientation hardly allowing for accumulation of strain, and which are oriented grains which can be preferentially grown in strain-induced grain growth. These oriented grains compete against the {411} oriented grain to be preferentially grown. In this regard, these oriented grains are disadvantageous because a magnetization easy axis direction (<100> direction) in a plane of the steel sheet is not so much present as compared with the {411} oriented grain or a random orientation selectivity in a plane of the steel sheet is hardly difficult to achieve and therefore, in a case in which such orientations are developed in strain-induced grain growth, magnetic characteristics are degraded or the steel sheet is increased in in-plane anisotropy. Therefore, Embodiment 1 is prescribed so that the abundance ratio of the {411} oriented grain in an orientation in which the Taylor factor is sufficiently small and strain by processing is hardly accumulated is ensured.

The area of an oriented grain in which the Taylor factor is 2.9 or less, including an oriented grain considered to compete against the {411} oriented grain in strain-induced grain growth, is defined as Sₜᵣₐ. As shown in Formula (6), the area ratio S₄₁₁/Sₜᵣₐ is set to 0.50 or more and predominance of growth of the {411} oriented grain is ensured. In a case in which the area ratio S₄₁₁/Sₜᵣₐ is less than 0.50, the {411} oriented grain is not sufficiently developed by strain-induced grain growth. The area ratio S₄₁₁/Sₜᵣₐ is preferably 0.80 or more, more preferably 0.90 or more. In this regard, the upper limit of the area ratio S₄₁₁/Sₜᵣₐ does not need to be particularly limited, and such an oriented grain in which the Taylor factor is 2.9 or less may be fully the {411} oriented grain (S₄₁₁/Sₜᵣₐ=1.00).

In Embodiment 1, not only the above crystal orientation, but also strain described below can be combined, thereby certainly growing the {411} oriented grain, and allowing more excellent magnetic characteristics to be obtained. It is necessary in Embodiment 1 to satisfy the following Formula (7), as a prescription associated with strain.

K₄₁₁/K_{tyl}≤0.990 (7)

A requirement associated with strain is prescribed by Formula (7). Formula (7) represents the ratio between the strain accumulated on the {411} oriented grain (average KAM value) and the strain accumulated on an oriented grain in which the Taylor factor is more than 2.9 (average KAM value). The KAM value here means the difference in orientation between adjacent measurement points in the same grain, and the KAM value is higher at a location in which strain is large. For example, in a case in which compression deformation is performed in the sheet thickness direction in a plane strain state in a plane in parallel with the sheet thickness direction and the rolling direction, from a crystallographic viewpoint, namely, in a case in which the steel sheet is simply rolled, the ratio K₄₁₁/K_{tyl} between K₄₁₁ and K_{tyl} is generally less than 1. However, strain depending on a crystal orientation microscopically observed takes a variety of forms in a factual manner, due to the influences by bonds with an adjacent crystal grain, a precipitate present in a crystal grain, and furthermore a macroscopical variation in deformation, including contact with a tool (rolling roll or the like) during deformation. Therefore, the influence by a purely geometrical orientation, due to the Taylor factor, hardly appears. For example, even in the case of grains which are the same in orientation, a very large variation is formed depending on the grain size, the grain form, the orientation and grain size of an adjacent grain, the precipitate state, the position in the sheet thickness direction, or the like. Furthermore, even in the case of one crystal grain, a strain distribution is largely varied, for example, between the vicinity of the grain boundary and the grain interior, or by formation of a deformation band.

In consideration of such variations, the K₄₁₁/K_{tyl} is set to 0.990 or less in order to obtain excellent magnetic characteristics in Embodiment 1. In a case in which the K₄₁₁/K_{tyl} is more than 0.990, specialty of a region to be subjected to encroachment is lost, whereby strain-induced grain growth hardly occurs. The K₄₁₁/K_{tyl} is preferably 0.970 or less, more preferably 0.950 or less.

The crystal grain size in the metal structure of the non-oriented electromagnetic steel sheet of Embodiment 1, in a state after skin pass rolling, is not particularly limited. The reason for this is because a relation with the crystal grain size in a state in which appropriate strain-induced grain growth occurs by subsequent final annealing is not so strong. In other words, whether or not objective appropriate strain-induced grain growth occurs can be almost determined by not only the chemical composition of the steel sheet, but also a relation of the amount of presence with respect to each crystal orientation (area) and a relation of the amount of strain with respect to each orientation.

However, in a case in which the crystal grain size is too coarse, grain growth, although induced by strain, hardly sufficiently occurs in a practical temperature range. In a case in which the crystal grain size is too coarse, degradation of magnetic characteristics is also hardly avoided. Therefore, a practical average crystal grain size is preferably 300 μm or less, more preferably 100 μm or less, still more preferably 50 μm or less, particularly preferably 30 μm or less. As the crystal grain size is finer, development of an objective crystal orientation by strain-induced grain growth in appropriate control of a crystal orientation and a distribution of strain is easily recognized. However, in a case in which the crystal grain size is too fine, the difference in amount of strain with respect to each crystal orientation is hardly formed due to bonds with an adjacent grain in processing for imparting strain, as described above. The average crystal grain size is preferably 3 μm or more, more preferably 8 μm or more, still more preferably 15 μm or more, from this viewpoint.

### Embodiment 2

In Embodiment 1 described above, features of the steel sheet are prescribed by identifying strain of the steel sheet by the KAM value. On the contrary, Embodiment 2 prescribes a steel sheet obtained by annealing the steel sheet described in Embodiment 1 for a sufficiently time and furthermore performing grain growth. Such a steel sheet, in which strain-induced grain growth is substantially completed and as a result, strain is substantially completely released, is thus very preferred in terms of characteristics. In other words, a steel sheet obtained by growing the {411} oriented grain by strain-induced grain growth and furthermore subjecting the resultant to normal grain growth by final annealing until substantially complete release of strain is a steel sheet in which accumulation in the {411} orientation is stronger. In Embodiment 2, the crystal orientation and the crystal grain size of a steel sheet (namely, non-oriented electromagnetic steel sheet obtained by subjecting the non-oriented electromagnetic steel sheet after skin pass rolling, to final annealing) obtained by a heat treatment performed with the steel sheet described in Embodiment 1, as a material, are described.

The crystal orientation of the steel sheet obtained by performing final annealing satisfies the following Formula (8) to Formula (11).

Formula (8) is different in numerical value range, as compared with Formula (3) associated with the non-oriented electromagnetic steel sheet after skin pass rolling. The {411} oriented grain is further grown by strain-induced grain growth occurring during final annealing and the area thereof is increased, whereby magnetic characteristics on all-direction average (average in the rolling direction, the width direction, a direction of 45 degrees with respect to the rolling direction, and a direction of 135 degrees with respect to the rolling direction) are improved.

The prescriptions of Formula (9) to Formula (11) are different in numerical value range from those of Formula (4) to Formula (6) associated with the non-oriented electromagnetic steel sheet after skin pass rolling. The reason for this is because not only the {411} oriented grain is further grown by strain-induced grain growth occurring during final annealing and the area thereof is increased, an oriented grain in which the Taylor factor is more than 2.9 is subjected to encroachment by the {411} oriented grain and the area thereof is further decreased.

S₄₁₁/S₁₀₀>2.00 (8)

S_{tyl}/Sₜₒₜ<0.55 (9)

S₄₁₁/Sₜₒₜ>0.30 (10)

S₄₁₁/Sₜᵣₐ≥0.60 (11)

In Embodiment 2, the area ratio S_{tyl}/Sₜₒₜ is set to less than 0.55. The total area S_{tyl} may be zero. The upper limit of the area ratio S_{tyl}/Sₜₒₜ is determined as one of parameters exhibiting the degree of progression of {411} oriented grain growth. An area ratio S_{tyl}/Sₜₒₜ of 0.55 or more indicates that an oriented grain having a Taylor factor of more than 2.9, to be under encroachment, is not sufficiently under encroachment at the stage of strain-induced grain growth. In this case, magnetic characteristics are not sufficiently enhanced. The area ratio S_{tyl}/Sₜₒₜ is preferably 0.40 or less, more preferably 0.30 or less. A lower area ratio S_{tyl}/Sₜₒₜ is more preferred, whereby the lower limit is not defined and may also be 0.00.

In Embodiment 2, the area ratio S₄₁₁/Sₜₒₜ is set to more than 0.30. An area ratio S₄₁₁/Sₜₒₜ of 0.30 or less does not allow for magnetic characteristics sufficiently enhanced. The area ratio S₄₁₁/Sₜₒₜ is preferably 0.40 or more, more preferably 0.50 or more. A situation in which the area ratio S₄₁₁/Sₜₒₜ is 1.00 is a situation in which all the crystalline textures correspond to the {411} oriented grains and no any other oriented grain is present, and Embodiment 2 is also directed to this situation.

Also in Embodiment 2, a relation between an oriented grain considered to compete against the {411} oriented grain in strain-induced grain growth and the {411} oriented grain is important as in Embodiment 1. In a case in which the area ratio S₄₁₁/Sₜᵣₐ is sufficiently large, predominance of growth of the {411} oriented grain is ensured even in the state of normal grain growth after strain-induced grain growth, and magnetic characteristics are improved. In a case in which the area ratio S₄₁₁/Sₜᵣₐ is less than 0.60, the {411} oriented grain is sufficiently developed by strain-induced grain growth, an oriented grain in which the Taylor factor is small, other than the {411} oriented grain, is considerably grown in the state of normal grain growth after strain-induced grain growth, and the in-plane anisotropy of magnetic characteristics is also increased. Accordingly, in Embodiment 2, the area ratio S₄₁₁/Sₜᵣₐ is set to 0.60 or more. The area ratio S₄₁₁/Sₜᵣₐ is preferably 0.70 or more, more preferably 0.80 or more. In this regard, the upper limit of the area ratio S₄₁₁/Sₜᵣₐ does not need to be particularly limited, an oriented grain in which the Taylor factor is 2.9 or less may be fully the {411} oriented grain.

The range of the average crystal grain size is not particularly limited, and, in a case in which the average crystal grain size is too coarse, degradation of magnetic characteristics is also hardly avoided. Therefore, a practical average crystal grain size of the {411} oriented grain being a relatively coarse grain is preferably 500 μm or less in Embodiment 2, as in Embodiment 1. The average crystal grain size of the {411} oriented grain is more preferably 400 μm or less, still more preferably 300 μm or less, particularly preferably 200 μm or less. In this regard, the lower limit of the average crystal grain size of the {411} oriented grain is determined in consideration of a state in which sufficiently preferential growth in the {411} orientation is ensured, and the average crystal grain size of the {411} oriented grain is preferably 40 μm or more, more preferably 60 μm or more, still more preferably 80 μm or more.

### [Characteristics]

The non-oriented electromagnetic steel sheet after final annealing, in which the chemical composition and the metal structure are controlled as descried above, thus can obtain excellent magnetic characteristics (low iron loss) not only on average in the rolling direction and the width direction, but also on all-direction average (average in the rolling direction, width direction, a direction of 45 degrees with respect to the rolling direction, and a direction of 135 degrees with respect to the rolling direction).

The rolling direction and the width direction mentioned here mean the rolling direction and the width direction of the resulting non-oriented electromagnetic steel sheet.

A non-oriented electromagnetic steel sheet of Embodiment 2 is most excellent in magnetic characteristics in a 45° direction among three directions in which the angles formed with the rolling direction are 0°, 45°, and 90°. In Embodiment 2, magnetic characteristics in a 45° direction correspond to the average value of magnetic characteristics with respect to two directions forming +45° and −45° with respect to the rolling direction.

In a case in which the magnetic flux density of the non-oriented electromagnetic steel sheet of Embodiment 2 is measured, the magnetic flux density B₅₀ in a 45° direction with respect to the rolling direction is preferably 1.75 T or more. The non-oriented electromagnetic steel sheet according to Embodiment 2 is high in magnetic flux density in a 45° direction with respect to the rolling direction, is small in-plane anisotopy, and achieves a high magnetic flux density even on the all-direction average.

In the non-oriented electromagnetic steel sheet of Embodiment 2, in a case in which the value of the magnetic flux density B₅₀ in the rolling direction is B_{50L}, the value of the magnetic flux density B₅₀ in a 45° direction with respect to the rolling direction is B_{50D}, and the value of the magnetic flux density B₅₀ in a 90° direction with respect to the rolling direction is B_{50C}, an anisotropy of the magnetic flux densities is observed in which B_{50D} is relatively high and B_{50L} and B_{50C} are relatively low.

The non-oriented electromagnetic steel sheet of Embodiment 2 more preferably satisfies the following Formula (A) with the of B_{50D} and the average value of B_{50L} and B_{50C}.

|B_{50D}−(B_{50L}+B_{50C})/2|≤0.2 (A)

The lower limit of the value of the left member of Formula (A) is not particularly limited, and is preferably zero.

Measurement of the magnetic flux density can be performed with single plate magnetic measurement equipment by cutting out a 55-mm square sample in the direction at 45°, 0°, or the like with respect to the rolling direction.

Magnetic measurement may be performed by measurement methods described in JIS C 2550-1 (2011) and JIS C 2550-3 (2019), or may be performed by a measurement method described in JIS C 2556 (2015). In a case in which the sample is minute and the above measurement in JIS cannot be made, an electromagnetic circuit may be measured with an apparatus in which a 55-mm square test piece according to JIS C 2556 (2015) or a further minute test piece can be measured.

Next, one example of a method of producing the non-oriented electromagnetic steel sheet according to the embodiment is described. The non-oriented electromagnetic steel sheet according to the embodiment is obtained by a production method including a hot rolling step, a cold rolling step, an intermediate annealing step, a skin pass rolling step, and a final annealing step).

Hereinafter, preferred conditions of each step are described.

Hereinafter, the Ar₃ temperature in the embodiment is the transformation temperature Ar₃ (°C) defined by the above Formula (1).

### (Hot-Rolling Step)

In the hot rolling step, hot rolling of a steel material satisfying the above chemical composition is carried out, to produce a hot-rolled steel sheet. The hot rolling step includes a heating process and a rolling process.

The steel material is, for example, a slab produced by usual continuous casting, and the steel material of the above composition is produced by a well-known method. For example, molten steel is produced in a converter furnace, an electric furnace, or the like. The molten steel produced is secondary-refined with a degassing installation or the like and thus formed into molten steel having the above chemical composition (the chemical composition is not substantially changed in subsequent steps). The molten steel is used and the slab is cast by a continuous casting method or an ingot-making method. The slab cast produced may be cogged.

In the heating process, the steel material having the above chemical composition is preferably heated to from 1000 to 1200 °C. Specifically, the steel material is inserted into a heating furnace or a soaking furnace and heated in the furnace. The retention time at the above heating temperature in the heating furnace or the soaking furnace is not particularly limited, and is, for example, from 30 to 200 hours.

In the rolling process, the steel material heated in the heating process is rolled multiple passes, to produce a hot-rolled steel sheet. Here, the “pass” means that the steel sheet passes through one rolling stand having a pair of work rolls and receives screw-down. In the hot rolling, for example, tandem rolling may be performed with a tandem rolling machine including a plurality of rolling stands aligned (each rolling stand having a pair of work rolls), to perform multiple-pass rolling, or reverse rolling with a pair of work rolls may be performed, to perform multiple-pass rolling. It is preferable from the viewpoint of productivity to perform multiple-pass rolling with a tandem rolling machine.

Rolling in the rolling process (rough rolling and finishing rolling) provides hot rolling by heating the above steel material. The steel material is, for example, a slab produced by usual continuous casting. The slab is heated at the Ar₃ temperature or more and in a temperature range in which the steel structure serves as a γ-phase. Hot rolling is started in a temperature range in which the steel structure serves as a γ-phase (hereinafter, this temperature range may be designated as “γ-region”), performed in the γ-region except for necessary some passes including the final pass of finishing rolling, performed in a temperature range in which an α-phase is present in the steel structure (hereinafter, this temperature range may be designated as “α-region”) necessary some passes including the final pass of finishing rolling, and thus completed. In general, the former stage to the middle stage of rough rolling and finishing rolling is performed in the γ-region, and the latter stage of finishing rolling is performed in the α-region. In the embodiment, rolling reduction in the temperature range of from the Ar₃ temperature to Ar₃+20 °C immediately before final rolling in the α-region is set to 10% or more. Furthermore, rolling reduction in the temperature range of from the finishing rolling temperature FT to less than the Ar₃ temperature is set to 15% or more in total in consideration of also the case of multiple-pass rolling.

The finishing rolling temperature FT refers to the surface temperature of the hot-rolled steel sheet immediately after finishing rolling.

The lower limit of the finishing rolling temperature FT is not particularly limited, and is set to, for example, Ar₃ temperature −100 °C or more.

Rolling in the temperature range more than Ar₃+20 °C immediately before final rolling in the α-region has almost no influence on the grain size of a processed γ-grain before phase transformation, leads to formation of a coarse processed α-grain after transformation, and is irrelevant to accumulation in the {411} crystal orientation in a final product.

In a case in which the rolling ratio in the temperature range of from the Ar₃ temperature to Ar₃+20 °C immediately before final rolling in the α-region is less than 10%, accumulation of strain in a processed γ-grain before phase transformation is lacked and a coarse processed α-grain is formed, to hardly result in the occurrence of accumulation in the {411} crystal orientation in a final product. The rolling ratio in the temperature range of from the Ar₃ temperature to Ar₃+20 °C is set to preferably 15% or more, more preferably 20% or more. The upper limit in total rolling reduction is not defined, but an upper limit of more than 40% causes the load of a rolling machine to be too high and thus the upper limit is preferably set to 40%.

In a case in which the total of rolling reduction in the temperature range of from the finishing rolling temperature FT to less than the Ars temperature in the final α-region is less than 15%, processing strain in the α-region cannot be accumulated in a processed α-grain after phase transformation from a processed γ-grain, and accumulation in the {411} crystal orientation in a final product hardly occurs. Rolling reduction in the temperature range of from the finishing rolling temperature FT to less than the Ars temperature is preferably 20% or more, more preferably 25% or more. The upper limit in total rolling reduction is not defined, but an upper limit of more than 40% causes the load of a rolling machine to be too high and thus the upper limit is preferably set to 40%.

In the embodiment, the rolling reduction RR0 in hot rolling is defined as follows.

Rolling reduction RR0(%)=(1−Sheet thickness after rolling in relevant temperature range in hot rolling/Sheet thickness before rolling in relevant temperature range in hot rolling)×100

The lower temperature in rolling in the α-region is not particularly limited, and is preferably set to 600 °C or more because a decrease in rolling temperature causes an increase in load of a rolling machine.

The above rolling temperature is considered to be varied above and below the determination temperature defined (Ar₃ temperature, or Ar₃+20 °C), during processing in a rolling pass, due to competition between a decrease in temperature by roll contact and a cooling lubricant and an increase in temperature by processing. The embodiment deals with such a circumstance, as follows.

It is assumed that the temperature at an inlet of a rolling pass is TPI (°C), the sheet thickness at the inlet is TCI (mm), the temperature at an outlet of the rolling pass is TPO (°C), and the sheet thickness at the outlet is TCO (mm), and furthermore the change in sheet thickness and the change in temperature in the rolling pass are simply changed with having a linear relation. In other words, it is assumed that, in a case in which the sheet thickness and the temperature at a specific point in a rolling pass are respectively TCa (mm) and TPa (C), the following Formula is always satisfied during the rolling pass.

(TCa−TCO)/(TCI−TCO)=(TPa−TPO)/(TPI−TPO)

Thus, even in the case of attainment of the determination temperature defined (Ar₃ temperature, or Ar₃+20 °C) in the present production method, during a rolling pass, the sheet thickness at this point of time can be determined.

In other words, the sheet thickness TCa (mm) at the point of time of the attainment of a specified temperature TPa (°C) during a rolling pass can be obtained by

TCa=TCO+(TCI−TCO)×(TPa−TPO)/(TPI−TPO).

It is to be noted here that the above assumption is made by also supposing that the temperature at an outlet of a rolling pass is higher than the temperature at an inlet thereof. In other words, it is determined that, even in a situation in which a steel sheet exhibiting a temperature TPI at the inlet of the pass, of less than the Ars temperature, is raised in temperature due to generation of heat by processing in the pass and is discharged at a temperature TPO at the outlet, of the Ars temperature or more, rolling in the γ-region (the temperature range of from the Ar₃ temperature to Ar₃+20 °C), necessary for the disclosure, is provided at a later stage of the pass.

It is also considered that the variation in temperature, with the Ar₃ temperature being sandwiched, occurs over multiple passes. In such a case, in the embodiment, rolling conditions in the α-region are directed to “final rolling processing in the α-region”. Rolling conditions in the γ-region are directed to “rolling processing in the γ-region, immediately before the “final rolling processing in the α-region””. In other words, in a case in which the rolling temperature after the initiation of hot rolling in the γ-region is varied like γ-region (initiation of heat rolling)→α-region 1→γ-region 1→α-region 2→γ-region 2→α-region 3 (end of heat rolling) and also in a case in which the α-region 3 and the γ-region 2 are matched with conditions in the embodiment, the steel sheet of the disclosure can be obtained.

The rolling temperature in each pass can be measured with, for example, a temperature measuring instrument disposed at an inlet or an outlet of a rolling stand in which screw-down of a target pass is to be performed. It is not necessary to dispose a temperature measuring instrument at each of all inlets and outlets of a rolling stand in which the temperature range is in the range of the disclosure, and the rolling temperature of the rolling stand on the way may be calculated by calculation from the actual temperatures of respective temperature measuring instruments appropriately disposed in front of and behind the inlets and the outlets. It is rather usual in current hot rolling to perform control with the temperature by such calculation.

The finishing rolling temperature FT is preferably set to less than the Ar₃ temperature.

Thereafter, hot-rolled sheet annealing is not performed and the hot-rolled steel sheet is rolled up. The temperature during rolling up is preferably from more than 450 °C to 650 °C. The hot-rolled steel sheet after hot rolling is rolled up at from more than 450 °C to 650 °C, to allow strain introduced by heat rolling in the α-region to be moderately relaxed, thereby enabling a crystalline texture before cold rolling to be refined, having an influence on a recrystallization behavior during intermediate annealing, and promoting development of the {411} crystal orientation as compared with the {100} crystal orientation, at the stage of an intermediate annealed sheet. The effect of enabling the {411} crystal orientation excellent in magnetic characteristics to be enriched during bulging. The temperature during rolling up is more preferably from 500 °C to 600 °C, still more preferably 520 °C to 580 °C

### (Cold-Rolling Step)

In the cold rolling step, the hot-rolled steel sheet after the cooling step is cold-rolled, to obtain a cold-rolled steel sheet. Specifically, the hot-rolled steel sheet is cold-rolled through acid pickling after hot rolling. The rolling reduction in cold rolling is preferably set to from 80% to 92%. As the rolling reduction is higher, subsequent bulging more allows a crystal grain having the {411} crystal orientation to be easily grown, but more easily leads to degradation in sheet shape and makes operating difficult.

In a case in which cold rolling is performed, rolling so that the rolling shape ratio is 5.0 or less is preferably performed one or more passes. The rolling shape ratio is set to 5.0 or less, whereby shear strain is added and formation of the {411} crystal orientation during cold rolling is promoted. The rolling shape ratio is preferably 4.5 or less, still more preferably 4.0 or less, from the above viewpoints. The lower limit of the rolling shape ratio is not particularly defined, it is difficult to control the rolling shape ratio to less than 1.0, and thus this value is preferably defined as the lower limit.

The rolling shape ratio is defined by the following Formula (a).

Γ=ld/hm (a)

Herein, each symbol in Formula (a) is defined by the following.
Γ: rolling shape ratio
ld: projected length of arc
hm: average sheet thickness

The above ld and hm are calculated from the following Formulae (b) and (c).

ld=√(R×(H−h)) (b)

hm=(H+2h)/3 (c)

Herein, each symbol in Formula (b) and Formula (c) is defined by the following.
R: radius of roll
H: sheet thickness at inlet (sheet thickness before entrance into rolling machine of the pass)
h: sheet thickness at outlet (sheet thickness in exit from rolling machine of the pass)

### (Intermediate Annealing Step)

In the intermediate annealing step, the cold-rolled steel sheet is subjected to intermediate annealing. In the embodiment, the intermediate annealing temperature is controlled to less than 900 °C. The intermediate annealing temperature is preferably set to 800 °C or less, more preferably 750 °C or less. An intermediate annealing temperature of 900 °C or more causes excess crystal grain growth and accordingly hardly allows for progression of accumulation in the {411} crystal orientation even by application of skin pass rolling and final annealing described below. In a case in which the intermediate annealing temperature is too low to provide sufficient recrystallization, a crystal grain having the {411} crystal orientation is inhibited from being grown even by application of skin pass rolling and final annealing described below. Accordingly, the intermediate annealing temperature is preferably set to 600 °C or more, more preferably 700 °C or more. The temperature described here is set as a promise for continuous annealing, and the intermediate annealing time is preferably in the range of from 5 to 120 seconds. Such annealing temperature range and annealing time range are considered to correspond to suitable conditions for allowing the {411} crystal grain more than slightly generated until the cold rolling step to be formed in a state in which the grain is moderately grown by bulging and strain-induced grain growth easily occurs by application of skin pass rolling and final annealing described below.

### (Skin Pass Rolling Step)

In the skin pass rolling step, the steel sheet after the intermediate annealing step is subjected to skin pass rolling. In a case in which skin pass rolling and annealing are performed in the state of the {411} crystal orientation enriched by bulging, as described above, a crystal grain having the {411} crystal orientation is further grown. The reason for this is because there is a tendency for skin pass rolling to allow strain to be easily accumulated in a crystal grain having the {411} crystal orientation and allow strain to be hardly accumulated in a crystal grain belonging to one having an orientation group including the {111} plane orientation called γ-fiber such as {111}<112> or {111}<110>, and such a crystal grain having the {411} crystal orientation, with less strain, encroaches on such a γ-fiber oriented grain with the difference in strain, as driving force, in subsequent annealing. This encroachment phenomenon occurring with the difference in strain, as driving force, is called strain-induced grain boundary migration (hereinafter, SIBM). The rolling reduction in skin pass rolling is preferably set to from 5% to less than 25%. In a case in which the rolling reduction is less than 5%, the amount of strain is too small to allow for the occurrence of strain-induced grain boundary migration (hereinafter, SIBM) in subsequent annealing, and to expand a crystal grain having the {411} crystal orientation. In this regard, in a case in which the rolling reduction is 25% or more, the amount of strain is so large that recrystallization nucleation (hereinafter, Nucleation) occurs in which a new crystal grain is generated in a crystal grain having a γ-fiber orientation. Since a grain to be generated mostly corresponds to a crystal grain having a γ-fiber orientation in this Nucleation, magnetic characteristics are deteriorated. The rolling reduction in skin pass rolling is preferably set to from 5% to 15% from the viewpoint of allowing for a higher average magnetic flux density and a smaller in-plane anisotopy.

In a case in which the non-oriented electromagnetic steel sheet is allowed to have the above strain distribution, the rolling reductions in cold rolling and skin pass rolling are preferably adjusted so that 5<RR2<25 is satisfied in a case in which the rolling reduction (%) in skin pass rolling is RR2.

The rolling reduction RR1 (%) in cold rolling is defined as follows.

Rolling reduction RR1(%)=(1−Sheet thickness after final pass rolling in cold rolling/Sheet thickness before first pass rolling in cold rolling)×100

The rolling reduction RR2 (%) in skin pass rolling is defined as follows.

Rolling reduction RR2(%)=(1−Sheet thickness after final pass rolling in skin pass rolling/Sheet thickness before first pass rolling in skin pass rolling)×100

### (Final Annealing Step)

In the final annealing step, the steel sheet after skin pass rolling is subjected to final annealing. This final annealing generates SIBM with the difference in strain, as driving force, with respect to each crystal orientation due to skin pass rolling, preferentially grows a crystal grain having the {411} crystal orientation, as an object of the disclosure, and increases the degree of accumulation in the {411} crystal orientation of the steel sheet. Such annealing conditions can be appropriately set with confirmation of generation of SIBM, by those skilled in the art, and are not particularly limited, and examples can include continuous annealing at from 700 to 950 °C for 1 to 100 seconds, or batch annealing at from 650 to 850 °C for from 0.5 to 2 hours.

The non-oriented electromagnetic steel sheet according to the embodiment can be produced as above. However, this production method is one example of the method of producing the non-oriented electromagnetic steel sheet of the embodiment, and is not meant to limit the production method strain removal annealing.

The non-oriented electromagnetic steel sheet according to the embodiment can be produced as above.

The final annealing step can be performed after skin pass rolling with, for example, a steel sheet coil from a steel sheet manufacturer, or a cut steel sheet. Alternatively, such final annealing can also be performed with a core shape obtained after shipping without final annealing performed after skin pass rolling, processing of a steel sheet into a predetermined shape serving as a motor core in a motor manufacturer, and layering of the resultant. The latter case can be performed also as “strain removal annealing” commonly performed with respect to a motor core in a motor manufacturer.

Such final annealing may also be performed as final annealing to be performed two or more times in both a steel sheet manufacturer and a motor manufacturer. Such final annealing after skin pass rolling can be adjusted, to adjust the amount of the remaining strain, the crystal grain size, and the degree of development of the {411} orientation. A steel sheet in the state of being small in amount of the remaining strain or being relatively small in crystal grain size is high in strength, and is used particularly as a non-oriented electromagnetic steel sheet for a rotor core and thus is suitable also in order to suppress deformation due to centrifugal force associated with core rotation. In this regard, a steel sheet in which strain is sufficiently released and the crystal grain size is made coarse is used particularly as a non-oriented electromagnetic steel sheet for a stator core and thus is suitable in order to suppress iron loss.

An iron steel member formed from the non-oriented electromagnetic steel sheet according to the embodiment is applied to, for example, an iron core (motor core) for a rotating electrical machine. In this case, an individual flat-shaped thin sheet is cut out from the non-oriented electromagnetic steel sheet according to the embodiment and such a flat-shaped thin sheet is appropriately layered, to produce an iron core used in a rotating electrical machine. This iron core, to which a non-oriented electromagnetic steel sheet having excellent magnetic characteristics is applied, is thus kept low in iron loss and a rotating electrical machine having an excellent torque is realized. An iron steel member formed from the non-oriented electromagnetic steel sheet according to the embodiment can be applied to a product other than the iron core for a rotating electrical machine, for example, an iron core for a linear motor, a static device (a reactor or a transformer), or the like.

### EXAMPLES

Next, a non-oriented electromagnetic steel sheet according to an embodiment of the disclosure is specifically described with reference to Examples. Examples shown below are merely illustrative for such a non-oriented electromagnetic steel sheet according to an embodiment of the disclosure, and the non-oriented electromagnetic steel sheet according to the disclosure is not intended to be limited to the following Examples.

Ingots of components shown in Table 1 below were produced by casting molten steel. In Table 1, the column “Co and the like” indicates the contents of Co, Pt, Pb, and Au. Thereafter, the ingots produced were each hot-rolled under conditions shown in Table 1, to obtain a hot-rolled sheet. Next, cold rolling under conditions shown in Table 1 was performed, to obtain a cold-rolled sheet.

The cold-rolled sheet was subjected to intermediate annealing in a non-oxidative atmosphere at a temperature shown in Table 2, for 30 seconds, and then the second cold rolling (skin pass rolling) at a rolling reduction shown in Table 2.

Next, in order to examine a texture, one part of the steel sheet was cut and removed, such a test piece obtained by cutting and removing was reduced in thickness to a thickness of ⅞, and this processed plane (polished plane obtained by polishing the steel sheet by ⅛ of the steel sheet from a sheet surface) was subjected to EBSD observation (Step interval: 0.3 μm) in the above manner. The area and the average KAM value of each type of an oriented grain shown in Table 3 were determined by EBSD observation.

The steel sheet was subjected to annealing at 800 °C for 2 hours, as final annealing. A 55-mm square sample piece was collected as a measurement sample, from the steel sheet after final annealing. Here, a sample in which one side of the sample piece was parallel to the rolling direction and a sample having a slope of 45 degrees to the rolling direction were collected. The samples were each collected with a shear cutter.

Next, in order to examine a texture, one part of the steel sheet was cut and removed, such a test piece obtained by cutting and removing was reduced in thickness to a thickness of ⅞, and this processed plane (polished plane obtained by polishing the steel sheet by ⅛ of the steel sheet from a sheet surface) was subjected to EBSD observation (Step interval: 2.0 μm) in the above manner. The area and the average KAM value of each type of an oriented grain shown in Table 3 were determined by EBSD observation.

The magnetic flux density B_{50L} in the rolling direction, the magnetic flux density B_{50D} in a 45° direction with respect to the rolling direction, and the magnetic flux density B_{50C} in a 90° direction with respect to the rolling direction were measured according to JIS C2556 (2015). The measurement results are shown in Table 3. The “Average value” shown in Table 3 represents the all-direction average value of the magnetic flux density B₅₀ (the average value of the magnetic flux density B₅₀ in the rolling direction, in a 90° direction with respect to the rolling direction, and in a) 45° (135° direction with respect to the rolling direction).

The rollability was evaluated as follows. In a case in which a position of 10 m from a tip top part) in the longitudinal direction of the outermost periphery of a cold-rolled sheet coil, in the longitudinal direction, a position (middle part) reaching a length of ½ with respect to the entire length in the longitudinal direction of the coil, from the tip in the longitudinal direction of the outermost periphery of the coil, and a position of 10 m from a tip (bottom part) in the longitudinal direction of the innermost periphery of the coil, in the longitudinal direction, were each set as the center and a region was set by a length of 1 m from the center in the longitudinal direction, a case in which a crack of 1 cm or more in length occurred at two or more locations in total on each of both end surfaces in the sheet width direction of the coil was rated as “N” and any case other than such a case was rated as “Y”.

In the present Examples, the cold-rolled sheet coil was adopted as an evaluation object of rollability. In the case of evaluation of a steel sheet cut out from the cold-rolled sheet coil, both end surfaces in the sheet width direction may be each observed at three or more different positions in the longitudinal direction (rolling direction) of the steel sheet, in the same manner as described above. For example, observation may be performed in the range of about 1/10 of the whole length in the longitudinal direction of the steel sheet with, as the center, each of positions of about 1/10, ½, and 9/10 with respect to the length in the longitudinal direction of the steel sheet, and the whole length in the longitudinal direction of the steel sheet may be here set to 1 m or more.

TABLE 1-1
Chemical composition (balance: Fe and impurities)

| | | | | | | | | | | Total of |
|---|---|---|---|---|---|---|---|---|---|---|
| | | | | | | | | | | Mn, Cu, |
| Type | C | Si | sol. Al | S | N | P | Mn | Cu | Ni | and Ni |
| of | [% by | [% by | [% by | [% by | [% by | [% by | [% by | [% by | [% by | [% by |
| steel | mass] | mass] | mass] | mass] | mass] | mass] | mass] | mass] | mass] | mass] |
| A01 | 0.0018 | 2.80 | 0.02 | 0.002 | 0.0018 | 0.010 | 2.40 | 1.30 | 0.70 | 4.40 |
| A02 | 0.0052 | 3.60 | 0.17 | 0.004 | 0.0036 | 0.020 | 2.40 | 0.02 | 0.01 | 2.43 |
| A03 | 0.0089 | 3.00 | 0.43 | 0.005 | 0.0016 | 0.010 | 2.40 | 0.02 | 0.02 | 2.44 |
| A04 | 0.0043 | 2.80 | 0.15 | 0.004 | 0.0025 | 0.030 | 1.60 | 0.40 | 0.30 | 2.30 |
| A05 | 0.0018 | 2.50 | 0.15 | 0.007 | 0.0018 | 0.010 | 2.10 | 0.02 | 0.01 | 2.13 |
| A06 | 0.0011 | 2.10 | 0.23 | 0.004 | 0.0044 | 0.040 | 0.30 | 1.30 | 0.70 | 2.30 |
| A07 | 0.0036 | 3.40 | 0.31 | 0.003 | 0.0018 | 0.010 | 2.40 | 0.02 | 0.02 | 2.44 |
| A08 | 0.0023 | 2.80 | 0.15 | 0.004 | 0.0053 | 0.120 | 2.40 | 0.03 | 0.01 | 2.44 |
| A09 | 0.0032 | 2.50 | 0.15 | 0.004 | 0.0018 | 0.020 | 2.40 | 0.02 | 0.03 | 2.45 |
| A10 | 0.0061 | 2.40 | 0.46 | 0.002 | 0.0026 | 0.010 | 0.70 | 0.04 | 0.02 | 0.76 |
| A11 | 0.0018 | 2.10 | 0.10 | 0.004 | 0.0018 | 0.030 | 0.30 | 0.02 | 0.03 | 0.35 |
| A12 | 0.0023 | 2.80 | 0.15 | 0.001 | 0.0032 | 0.010 | 1.40 | 0.50 | 0.30 | 2.20 |
| A13 | 0.0044 | 2.40 | 0.82 | 0.004 | 0.0018 | 0.010 | 3.35 | 0.05 | 0.01 | 3.41 |
| A14 | 0.0022 | 1.90 | 0.06 | 0.002 | 0.0020 | 0.080 | 0.50 | 0.06 | 0.01 | 0.57 |
| A15 | 0.0026 | 2.30 | 0.03 | 0.003 | 0.0019 | 0.020 | 2.30 | 0.03 | 0.02 | 2.35 |
| A16 | 0.0021 | 1.90 | 0.20 | 0.003 | 0.0022 | 0.010 | 3.50 | 0.02 | 0.01 | 3.53 |
| A17 | 0.0025 | 2.50 | 0.30 | 0.007 | 0.0092 | 0.010 | 2.20 | 0.05 | 0.03 | 2.28 |
| A18 | 0.0021 | 1.90 | 0.10 | 0.002 | 0.0023 | 0.350 | 1.90 | 0.06 | 0.03 | 1.99 |
| A19 | 0.0018 | 3.10 | 0.01 | 0.05 | 0.0023 | 0.009 | 1.30 | 0.04 | 0.03 | 1.37 |
| A20 | 0.0026 | 3.00 | 0.30 | 0.008 | 0.0024 | 0.010 | 1.00 | 0.80 | 0.50 | 2.30 |
| A21 | 0.0025 | 2.30 | 0.12 | 0.007 | 0.0021 | 0.010 | 0.50 | 0.03 | 0.02 | 0.55 |

TABLE 1-2

| | Co and | Total of Mn, | | | | | | | Mg and | |
|---|---|---|---|---|---|---|---|---|---|---|
| Type | the like | Cu, Ni, Co, Pt, | Ti | Nb | Mo | Cr | Sn | Sb | the like | |
| of | [% by | Pb, and Au | [% by | [% by | [% by | [% by | [% by | [% by | [% by | Ar₃ |
| steel | mass] | [% by mass] | mass] | mass] | mass] | mass] | mass] | mass] | mass] | °C |
| A01 | | 4.40 | | | | | | | — | 640 |
| A02 | | 2.43 | 0.0050 | | | | | | Ca: 0.002, | 866 |
| | | | | | | | | | Ce: 0.002 | |
| A03 | Co: 0.05 | 2.49 | 0.0036 | | | | | | — | 862 |
| A04 | | 2.30 | 0.0050 | 0.0031 | | | | | — | 878 |
| A05 | | 2.13 | 0.0042 | | | | | | Mg: 0.005 | 862 |
| A06 | | 2.30 | 0.0015 | | | 0.1 | | | — | 890 |
| A07 | Pb: 0.02 | 2.46 | 0.0023 | | | | | 0.03 | — | 867 |
| A08 | | 2.44 | 0.0036 | | | | | | Ba: 0.002, | 866 |
| | | | | | | | | | Zn: 0.002 | |
| A09 | | 2.45 | 0.0011 | | | | | | Pr: 0.002 | 827 |
| A10 | | 0.76 | 0.0023 | | 1.5 | | | | | 867 |
| A11 | | 0.35 | 0.0010 | | | | | | Sr: 0.002, | 1066 |
| | | | | | | | | | Cd: .0002 | |
| A12 | | 2.20 | 0.0009 | | | 2.1 | | | | 788 |
| A13 | | 3.41 | 0.0043 | | | | | | | 758 |
| A14 | | 0.57 | 0.0023 | | 0.5 | | | | La: 0.002, | 982 |
| | | | | | | | | | Nd: 0.002 | |
| A15 | | 2.35 | 0.0033 | | | | 0.02 | | — | 823 |
| A16 | | 3.53 | 0.0019 | | | | | | — | 678 |
| A17 | Pt: 0.01 | 2.29 | 0.0008 | | | | | | | 857 |
| A18 | | 1.99 | 0.0015 | | | | | | | 954 |
| A19 | Au: 0.01 | 1.39 | 0.0032 | | | | | | | 963 |
| A20 | | 2.30 | 0.0013 | | | | 0.1 | | | 906 |
| A21 | | 0.55 | 0.0010 | | | | | | Sr: 0.002, | 1043 |
| | | | | | | | | | Cd: .0002 | |

TABLE 2-1

| | | | | | | | | | | Inter- | Skin | |
|---|---|---|---|---|---|---|---|---|---|---|---|---|
| | | | | | | | | | | mediate | pass | Final |
| | | | Hot rolling step | | | | | | | annealing | rolling | annealing |
| | | Trans- | | Rolling | Rolling | Finishing | | Cold-rolling | | step | step | step |
| | | formation | | reduction | reduction | rolling | Rolling- | step | | Annealing | Rolling | Annealing |
| | | point | Heating | from Ar₃ + | from less | temper- | up | Rolling | | temper- | reduction | temper- |
| | Type | Ar₃ tem- | temper- | 20 °C | than Ar₃ | ature | temper- | reduction | Rolling | ature | RR2 in | ature |
| | of | perature | ature | to Ar₃ | to FT | FT | ature | RR1 | shape | T1 | rolling | T2 |
| No. | steel | [°C] | [°C] | [%] | [%] | [°C] | [°C] | [%] | ratio | [°C] | [%] | [°C] |
| 1 | A01 | 640 | 1150 | 21 | 25 | 610 | 400 | 89 | 4.3 | 700 | 10 | 800 |
| 2 | A02 | 866 | 1150 | 20 | 24 | 835 | 570 | 89 | 4.1 | 700 | 10 | 800 |
| 3 | A03 | 862 | 1150 | 19 | 25 | 830 | 570 | 89 | 4.2 | 700 | 10 | 800 |
| 4 | A04 | 878 | 1150 | 20 | 26 | 850 | 570 | 90 | 4.3 | 700 | 10 | 800 |
| 5 | A05 | 862 | 1150 | 18 | 25 | 830 | 570 | 89 | 4.2 | 700 | 10 | 800 |
| 6 | A06 | 890 | 1150 | 20 | 24 | 865 | 570 | 89 | 4.2 | 700 | 10 | 800 |
| 7 | A07 | 867 | 1150 | 22 | 25 | 835 | 570 | 89 | 4.2 | 700 | 10 | 800 |
| 8 | A08 | 866 | 1150 | 20 | 25 | 835 | 570 | 88 | 4.1 | 700 | 10 | 800 |
| 9 | A09 | 827 | 1150 | 19 | 23 | 800 | 570 | 89 | 4.2 | 700 | 10 | 800 |
| 10 | A10 | 867 | 1150 | 20 | 25 | 835 | 570 | 89 | 4.1 | 700 | 10 | 800 |
| 11 | A11 | 1066 | 1200 | 21 | 24 | 1035 | 570 | 89 | 4.2 | 700 | 10 | 800 |
| 12 | A12 | 788 | 1150 | 20 | 25 | 760 | 570 | 89 | 4.2 | 700 | 10 | 800 |
| 13 | A13 | 758 | 1150 | 21 | 26 | 730 | 570 | 89 | 4.3 | 700 | 10 | 800 |
| 14 | A14 | 982 | 1150 | 20 | 25 | 950 | 570 | 89 | 4.2 | 700 | 10 | 800 |
| 15 | A15 | 823 | 1150 | 20 | 24 | 790 | 570 | 89 | 4.2 | 700 | 10 | 800 |
| 16 | A16 | 678 | 1150 | 22 | 25 | 650 | 450 | 89 | 4.2 | 700 | 10 | 800 |
| 17 | A17 | 857 | 1150 | 18 | 23 | 830 | 550 | 90 | 4.2 | 700 | 10 | 800 |
| 18 | A18 | 954 | 1150 | 21 | 24 | 920 | 550 | 90 | 43 | 700 | 10 | 850 |
| 19 | A19 | 963 | 1150 | 20 | 22 | 890 | 500 | 90 | 4.2 | 700 | 10 | 800 |
| 20 | A20 | 906 | 1150 | 20 | 24 | 870 | 500 | 90 | 4.1 | 700 | 10 | 780 |
| 21 | A21 | 1043 | 1200 | 21 | 24 | 998 | 570 | 89 | 4.2 | 700 | 10 | 800 |

TABLE 2-2

| | | | | | | | | | | Inter- | Skin | |
|---|---|---|---|---|---|---|---|---|---|---|---|---|
| | | Trans- | | | | | | | | mediate | pass | Final |
| | | for- | Hot rolling step | | | | | | | annealing | rolling | annealing |
| | | mation | | Rolling | Rolling | Finishing | | Cold-rolling | | step | step | step |
| | | point | | reduction | reduction | rolling | Rolling- | step | | Annealing | Rolling | Annealing |
| | | Ar₃ | Heating | from Ar₃ + | from less | temper- | up | Rolling | Rolling | temper- | reduction | temper- |
| | Type | temper- | temper- | 20 °C | than Ar₃ | ature | temper- | reduction | shape | ature | RR2 in | ature |
| | of | ature | ature | to Ar₃ | to FT | FT | ature | RR1 | ratio | T1 | rolling | T2 |
| No. | steel | [°C] | [°C] | [%] | [%] | [°C] | [°C] | [%] | [—] | [°C] | [%] | [°C] |
| 22 | A02 | 866 | 1150 | 7 | 27 | 825 | 570 | 90 | 4.1 | 700 | 12 | 800 |
| 23 | A02 | 866 | 1150 | 19 | 25 | 830 | 570 | 75 | 4.1 | 700 | 12 | 800 |
| 24 | A02 | 866 | 1150 | 25 | 17 | 830 | 570 | 90 | 4.1 | 700 | 12 | 800 |
| 25 | A02 | 866 | 1150 | 21 | 10 | 835 | 570 | 90 | 4.1 | 700 | 12 | 800 |
| 26 | A02 | 866 | 1150 | 20 | 25 | 835 | 400 | 90 | 4.1 | 700 | 12 | 800 |
| 27 | A02 | 866 | 1150 | 19 | 26 | 830 | 680 | 90 | 4.1 | 700 | 12 | 800 |
| 28 | A02 | 866 | 1150 | 20 | 24 | 830 | 570 | 90 | 4.1 | 700 | 3 | 800 |
| 29 | A02 | 866 | 1150 | 21 | 25 | 830 | 570 | 90 | 4.1 | 550 | 7 | 800 |
| 30 | A02 | 866 | 1150 | 20 | 26 | 830 | 570 | 90 | 4.1 | 700 | 30 | 800 |
| 31 | A15 | 823 | 1150 | 14 | 30 | 790 | 570 | 90 | 4.2 | 700 | 12 | 800 |
| 32 | A15 | 823 | 1150 | 19 | 25 | 790 | 570 | 90 | 4.2 | 1000 | 12 | 800 |
| 33 | A15 | 823 | 1150 | 20 | 24 | 790 | 570 | 90 | 8.9 | 700 | 12 | 800 |
| 34 | A15 | 823 | 1150 | 20 | 23 | 790 | 550 | 82 | 4.2 | 700 | 10 | 800 |
| 35 | A15 | 823 | 1100 | 20 | 28 | 730 | 500 | 90 | 4.1 | 700 | 10 | 850 |
| 36 | A15 | 823 | 1150 | 23 | 25 | 780 | 570 | 95 | 4.9 | 700 | 10 | 800 |
| 37 | A15 | 823 | 1150 | 11 | 15 | 800 | 600 | 85 | 4.3 | 680 | 0 | 800 |
| 38 | A15 | 823 | 1150 | 20 | 25 | 790 | 500 | 89 | 4.3 | 700 | 23 | 800 |

TABLE 3-1

| | | | | | | Results of EBSD | | | |
|---|---|---|---|---|---|---|---|---|---|
| | Results of EBSD observation | | | | | observation after | | | |
| | after skin pass rolling | | | | | at 800 °C for 2 hours | | | |
| | S₄₁₁/ | S_{tyl}/ | S₄₁₁/ | S₄₁₁/ | K₄₁₁/ | S₄₁₁/ | S_{tyl}/ | S₄₁₁/ | S₄₁₁/ |
| | S₁₀₀ | Sₜₒₜ | Sₜₒₜ | Sₜᵣₐ | K_{tyl} | S₁₀₀ | Sₜₒₜ | Sₜₒₜ | Sₜᵣₐ |
| No. | [—] | [—] | [—] | [—] | [—] | [—] | [—] | [—] | [—] |
| 1 | 0.91 | 0.72 | 0.14 | 0.49 | 0.980 | 1.67 | 0.36 | 0.27 | 0.42 |
| 2 | 1.82 | 0.56 | 0.32 | 0.73 | 0.979 | 3.40 | 0.11 | 0.76 | 0.86 |
| 3 | 1.78 | 0.58 | 0.30 | 0.71 | 0.979 | 3.93 | 0.06 | 0.81 | 0.84 |
| 4 | 2.13 | 0.65 | 0.24 | 0.69 | 0.984 | 4.00 | 0.07 | 0.83 | 0.90 |
| 5 | 1.56 | 0.69 | 0.21 | 0.67 | 0.978 | 3.10 | 0.06 | 0.75 | 0.80 |
| 6 | 1.67 | 0.63 | 0.25 | 0.67 | 0.982 | 3.54 | 0.04 | 0.79 | 0.82 |
| 7 | 2.01 | 0.54 | 0.33 | 0.72 | 0.980 | 4.08 | 0.12 | 0.73 | 0.83 |
| 8 | 1.89 | 0.60 | 0.27 | 0.66 | 0.980 | 4.25 | 0.04 | 0.85 | 0.89 |
| 9 | 1.92 | 0.44 | 0.42 | 0.75 | 0.979 | 4.08 | 0.11 | 0.79 | 0.88 |
| 10 | 1.73 | 0.56 | 0.32 | 0.73 | 0.983 | 3.02 | 0.10 | 0.74 | 0.82 |
| 11 | 0.97 | 0.92 | 0.02 | 0.25 | 0.978 | 1.23 | 0.32 | 0.25 | 0.37 |
| 12 | 1.69 | 0.73 | 0.18 | 0.68 | 0.980 | 2.42 | 0.12 | 0.63 | 0.72 |
| 13 | 1.01 | 0.83 | 0.10 | 0.59 | 0.987 | 1.98 | 0.10 | 0.63 | 0.70 |
| 14 | 1.87 | 0.59 | 0.28 | 0.68 | 0.985 | 3.54 | 0.07 | 0.81 | 0.87 |
| 15 | 1.92 | 0.55 | 0.32 | 0.70 | 0.980 | 3.66 | 0.11 | 0.74 | 0.83 |
| 16 | 0.98 | 0.82 | 0.02 | 0.11 | 0.980 | 1.76 | 0.54 | 0.28 | 0.61 |
| 17 | 1.67 | 0.75 | 0.16 | 0.64 | 0.979 | 3.10 | 0.41 | 0.36 | 0.61 |
| 18 | 1.02 | 0.68 | 0.26 | 0.81 | 0.980 | 3.58 | 0.05 | 0.73 | 0.77 |
| 19 | 1.59 | 0.65 | 0.33 | 0.94 | 0.978 | 3.26 | 0.15 | 0.75 | 0.88 |
| 20 | 1.53 | 0.59 | 0.38 | 0.93 | 0.980 | 2.10 | 0.21 | 0.67 | 0.85 |
| 21 | 1.08 | 0.83 | 0.18 | 1.06 | 0.980 | 2.15 | 0.33 | 0.42 | 0.63 |
| | Magnetic characteristics after | | | | | | | | |
| | annealing at 800 °C for 2 hours | | | | | | | | |
| | | | | | Left | | | | |
| | | | | | member of | | | | |
| | | | | Average | Formula | | | | |

| | B50L | B50D | B50C | value | (A) | | |
|---|---|---|---|---|---|---|---|
| No. | [T] | [T] | [T] | [T] | [T] | Rollability | Note |
| 1 | 1.520 | 1.772 | 1.490 | 1.639 | 0.267 | N | Com- |
| | | | | | | | parative |
| | | | | | | | Example |
| 2 | 1.601 | 1.735 | 1.556 | 1.657 | 0.156 | Y | Dis- |
| | | | | | | | closure |
| | | | | | | | Example |
| 3 | 1.605 | 1.761 | 1.571 | 1.674 | 0.174 | Y | Dis- |
| | | | | | | | closure |
| | | | | | | | Example |
| 4 | 1.641 | 1.776 | 1.615 | 1.702 | 0.147 | Y | Dis- |
| | | | | | | | closure |
| | | | | | | | Example |
| 5 | 1.606 | 1.758 | 1.571 | 1.673 | 0.170 | Y | Dis- |
| | | | | | | | closure |
| | | | | | | | Example |
| 6 | 1.628 | 1.740 | 1.592 | 1.675 | 0.130 | Y | Dis- |
| | | | | | | | closure |
| | | | | | | | Example |
| 7 | 1.605 | 1.755 | 1.575 | 1.672 | 0.165 | Y | Dis- |
| | | | | | | | closure |
| | | | | | | | Example |
| 8 | 1.592 | 1.762 | 1.566 | 1.671 | 0.183 | Y | Dis- |
| | | | | | | | closure |
| | | | | | | | Example |
| 9 | 1.602 | 1.763 | 1.571 | 1.675 | 0.177 | Y | Dis- |
| | | | | | | | closure |
| | | | | | | | Example |
| 10 | 1.621 | 1.777 | 1.577 | 1.688 | 0.178 | Y | Dis- |
| | | | | | | | closure |
| | | | | | | | Example |
| 11 | 1.540 | 1.692 | 1.512 | 1.609 | 0.166 | Y | Com- |
| | | | | | | | parative |
| | | | | | | | Example |
| 12 | 1.635 | 1.745 | 1.591 | 1.679 | 0.132 | Y | Dis- |
| | | | | | | | closure |
| | | | | | | | Example |
| 13 | 1.550 | 1.755 | 1.544 | 1.651 | 0.208 | N | Com- |
| | | | | | | | parative |
| | | | | | | | Example |
| 14 | 1.596 | 1.768 | 1.555 | 1.672 | 0.193 | Y | Dis- |
| | | | | | | | closure |
| | | | | | | | Example |
| 15 | 1.628 | 1.773 | 1.584 | 1.690 | 0.167 | Y | Dis- |
| | | | | | | | closure |
| | | | | | | | Example |
| 16 | 1.549 | 1.726 | 1.502 | 1.626 | 0.201 | N | Com- |
| | | | | | | | parative |
| | | | | | | | Example |
| 17 | 1.592 | 1.735 | 1.559 | 1.655 | 0.160 | Y | Dis- |
| | | | | | | | closure |
| | | | | | | | Example |
| 18 | 1.608 | 1.739 | 1.547 | 1.658 | 0.162 | Y | Dis- |
| | | | | | | | closure |
| | | | | | | | Example |
| 19 | 1.620 | 1.735 | 1.552 | 1.661 | 0.149 | Y | Dis- |
| | | | | | | | closure |
| | | | | | | | Example |
| 20 | 1.592 | 1.738 | 1.592 | 1.665 | 0.146 | Y | Dis- |
| | | | | | | | closure |
| | | | | | | | Example |
| 21 | 1.588 | 1.721 | 1.579 | 1.652 | 0.138 | Y | Dis- |
| | | | | | | | closure |
| | | | | | | | Example |

TABLE 3-2

| | Results of | | | | | Results of EBSD | | | |
|---|---|---|---|---|---|---|---|---|---|
| | EBSD observation | | | | | observation after | | | |
| | after skin pass rolling | | | | | at 800 °C for 2 hours | | | |
| | S₄₁₁/ | S_{tyl}/ | S₄₁₁/ | S₄₁₁/ | K₄₁₁/ | S₄₁₁/ | S_{tyl}/ | S₄₁₁/ | S₄₁₁/ |
| | S₁₀₀ | Sₜₒₜ | Sₜₒₜ | Sₜᵣₐ | K_{tyl} | S₁₀₀ | Sₜₒₜ | Sₜₒₜ | Sₜᵣₐ |
| No. | [—] | [—] | [—] | [—] | [—] | [—] | [—] | [—] | [—] |
| 22 | 0.89 | 0.72 | 0.15 | 0.53 | 0.989 | 1.60 | 0.27 | 0.46 | 0.63 |
| 23 | 1.01 | 0.16 | 0.45 | 0.53 | 0.979 | 1.02 | 0.52 | 0.25 | 0.52 |
| 24 | 1.75 | 0.49 | 0.36 | 0.70 | 0.979 | 2.90 | 0.19 | 0.62 | 0.77 |
| 25 | 0.92 | 0.69 | 0.18 | 0.57 | 0.979 | 1.58 | 0.12 | 0.76 | 0.86 |
| 26 | 0.76 | 0.69 | 0.17 | 0.52 | 0.991 | 1.27 | 0.29 | 0.61 | 0.86 |
| 27 | 0.82 | 0.55 | 0.21 | 0.47 | 0.990 | 1.34 | 0.13 | 0.75 | 0.86 |
| 28 | 1.51 | 0.62 | 0.23 | 0.60 | 1.030 | 2.79 | 0.55 | 0.29 | 0.64 |
| 29 | 1.82 | 0.89 | 0.17 | 1.57 | 0.979 | 1.72 | 0.38 | 0.18 | 0.29 |
| 30 | 0.96 | 0.73 | 0.38 | 1.40 | 1.013 | 1.83 | 0.1 | 0.23 | 0.26 |
| 31 | 1.92 | 0.58 | 0.30 | 0.70 | 0.980 | 3.26 | 0.07 | 0.76 | 0.82 |
| 32 | 0.89 | 0.66 | 0.02 | 0.06 | 1.001 | 1.24 | 0.14 | 0.71 | 0.83 |
| 33 | 0.92 | 0.51 | 0.26 | 0.53 | 0.989 | 1.97 | 0.11 | 0.49 | 0.55 |
| 34 | 1.12 | 0.22 | 0.57 | 0.73 | 0.980 | 2.01 | 0.27 | 0.45 | 0.06 |
| 35 | 1.01 | 0.20 | 0.77 | 0.96 | 0.970 | 3.36 | 0.15 | 0.44 | 0.52 |
| 36 | 2.30 | 0.21 | 0.83 | 1.04 | 0.978 | 1.95 | 0.42 | 0.31 | 0.53 |
| 37 | 1.15 | 0.52 | 0.36 | 0.75 | 0.980 | 2.02 | 0.58 | 0.31 | 0.74 |
| 38 | 2.02 | 0.49 | 0.33 | 0.65 | 0.986 | 2.11 | 0.15 | 0.55 | 0.65 |
| | Magnetic characteristics after | | | | | | | | |
| | annealing at 800 °C for 2 hours | | | | | | | | |
| | | | | | Left | | | | |
| | | | | | member of | | | | |
| | | | | Average | Formula | | | | |
| | B50L | B50D | B50C | value | (A) | | | | |

| No. | [T] | [T] | [T] | [T] | [T] | Rollability | Note |
|---|---|---|---|---|---|---|---|
| 22 | 1.550 | 1.736 | 1.509 | 1.633 | 0.207 | Y | Com- |
| | | | | | | | parative |
| | | | | | | | Example |
| 23 | 1.553 | 1.592 | 1.585 | 1.581 | 0.023 | Y | Com- |
| | | | | | | | parative |
| | | | | | | | Example |
| 24 | 1.589 | 1.732 | 1.555 | 1.652 | 0.160 | Y | Dis- |
| | | | | | | | closure |
| | | | | | | | Example |
| 25 | 1.555 | 1.750 | 1.508 | 1.641 | 0.219 | Y | Com- |
| | | | | | | | parative |
| | | | | | | | Example |
| 26 | 1.577 | 1.733 | 1.515 | 1.640 | 0.187 | Y | Com- |
| | | | | | | | parative |
| | | | | | | | Example |
| 27 | 1.589 | 1.752 | 1.502 | 1.649 | 0.207 | Y | Com- |
| | | | | | | | parative |
| | | | | | | | Example |
| 28 | 1.525 | 1.588 | 1.555 | 1.564 | 0.048 | Y | Com- |
| | | | | | | | parative |
| | | | | | | | Example |
| 29 | 1.553 | 1.592 | 1.586 | 1.581 | 0.023 | Y | Com- |
| | | | | | | | parative |
| | | | | | | | Example |
| 30 | 1.580 | 1.620 | 1.550 | 1.593 | 0.055 | Y | Com- |
| | | | | | | | parative |
| | | | | | | | Example |
| 31 | 1.592 | 1.758 | 1.552 | 1.665 | 0.186 | Y | Dis- |
| | | | | | | | closure |
| | | | | | | | Example |
| 32 | 1.562 | 1.623 | 1.562 | 1.593 | 0.061 | Y | Com- |
| | | | | | | | parative |
| | | | | | | | Example |
| 33 | 1.589 | 1.750 | 1.503 | 1.648 | 0.204 | Y | Com- |
| | | | | | | | parative |
| | | | | | | | Example |
| 34 | 1.582 | 1.723 | 1.572 | 1.650 | 0.146 | Y | Dis- |
| | | | | | | | closure |
| | | | | | | | Example |
| 35 | 1.593 | 1.725 | 1.505 | 1.637 | 0.176 | Y | Dis- |
| | | | | | | | closure |
| | | | | | | | Example |
| 36 | 1.572 | 1.605 | 1.598 | 1.595 | 0.020 | Y | Com- |
| | | | | | | | parative |
| | | | | | | | Example |
| 37 | 1.590 | 1.695 | 1.610 | 1.648 | 0.095 | Y | Com- |
| | | | | | | | parative |
| | | | | | | | Example |
| 38 | 1.605 | 1.709 | 1.592 | 1.654 | 0.111 | Y | Dis- |
| | | | | | | | closure |
| | | | | | | | Example |

A test piece of the steel sheet of No. 12 was reduced in thickness to a thickness of ½ of the thickness thereof, the processed plane was subjected to EBSD observation in the above manner, and the area and the average KAM value of each type of an oriented grain shown in Table 4 were determined. The results are shown, together with magnetic characteristics and rollability, in Table 4.

TABLE 4

| | | Results of | | | | | Results of EBSD | | | |
|---|---|---|---|---|---|---|---|---|---|---|
| | | EBSD observation | | | | | observation after | | | |
| | | after skin pass rolling | | | | | at 800 °C for 2 hours | | | |
| | | S₄₁₁/ | S_{tyl}/ | S₄₁₁/ | S₄₁₁/ | K₄₁₁/ | S₄₁₁/ | S_{tyl}/ | S₄₁₁/ | S₄₁₁/ |
| | Measurement | S₁₀₀ | Sₜₒₜ | Sₜₒₜ | Sₜᵣₐ | K_{tyl} | S₁₀₀ | Sₜₒₜ | Sₜₒₜ | Sₜᵣₐ |
| No | point | [—] | [—] | [—] | [—] | [—] | [—] | [—] | [—] | [—] |
| 12 | ⅞ | 1.69 | 0.73 | 0.18 | 0.68 | 0.980 | 2.42 | 0.12 | 0.63 | 0.72 |
| | thick- | | | | | | | | | |
| | ness | | | | | | | | | |
| | ½ | 1.73 | 0.73 | 0.17 | 0.63 | 0.992 | 2.40 | 0.13 | 0.64 | 0.74 |
| | thick- | | | | | | | | | |
| | ness | | | | | | | | | |
| | | Magnetic characteristics after | | | | | | | | |
| | | annealing at 800 °C for 2 hours | | | | | | | | |
| | | | | | | Left | | | | |
| | | | | | | member of | | | | |
| | | | | | Average | Formula | | | | |
| | Measurement | B50L | B50D | B50C | value | (A) | | | | |

| No | point | [T] | [T] | [T] | [T] | [T] | Rollability | Note |
|---|---|---|---|---|---|---|---|---|
| 12 | ⅞ | 1.635 | 1.745 | 1.591 | 1.679 | 0.132 | Y | Dis- |
| | thick- | | | | | | | closure |
| | ness | | | | | | | Exam- |
| | ½ | | | | | | | ple |
| | thick- | | | | | | | |
| | ness | | | | | | | |

### INDUSTRIAL APPLICABILITY

The disclosure can provide a non-oriented electromagnetic steel sheet which is small in-plane anisotopy and which has excellent magnetic characteristics on all-direction average, and thus is extremely industrially useful.

The disclosure of Japanese Patent Application No. 2023-001935 is herein incorporated by reference in its entirety.

All literature, patent applications, and technical standards described herein are herein incorporated by reference, as if each individual literature, patent application, and technical standard were specifically and individually indicated to be incorporated by reference.

1. A non-oriented electromagnetic steel sheet, comprising:
in percentage by mass,
C: 0.0100% or less;
Si: from 1.50% to 4.00%;
sol.Al: from 0.0001% to 1.0%;
S: 0.0100% or less;
N: 0.0100% or less;
Mn: 0.10% or more;
one kind or a plurality of kinds selected from Mn, Ni, or Cu: less than 2.50% in total;
Mo: from 0.0% to less than 2.5%;
Cr: from 0.0% to less than 2.5%;
Ti: from 0.000% to 0.005%;
Nb: from 0.000% to 0.005%;
Sn: from 0.000% to 0.400%;
Sb: from 0.000% to 0.400%;
P: from 0.000% to 0.400%; and
one kind or a plurality of kinds selected from the group consisting of Mg, Ca, Sr, Ba, Ce, La, Nd, Pr, Zn, and Cd: from 0.0000% to 0.0100% in total, wherein:
the non-oriented electromagnetic steel sheet has a chemical composition in which, in a case in which, in percentage by mass, a C content is [C], an Mo content is [Mo], a Cr content is [Cr], an Mn content is [Mn], an Ni content is [Ni], a Cu content is [Cu], an Si content is [Si], a sol.Al content is [sol.Al], and a P content is [P], a transformation temperature Ar₃ (°C) defined by the following Formula (1) is from 750 to 1050 °C and the balance consists of Fe and impurities, and
the following Formula (3) and Formula (4) to Formula (7) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, a total area of an oriented grain in which the Taylor factor M is 2.9 or less is defined as Sₜᵣₐ, an average KAM value of a {411} oriented grain is defined as K₄₁₁, and an average KAM value of an oriented grain in which the Taylor factor M is more than 2.9 is defined as K_{tyl}:
Ar₃ (°C)=1020−325×[C]+33×[Si]+287×[P]+80×[sol.Al]−120×([Mn]+[Mo]+[Cu])−46×([Cr]+[Ni]) (1)
M=(cosφ×cosλ)⁻¹ (2)
S₄₁₁/S₁₀₀>1.00 (3)
0.20≤S_{tyl}/Sₜₒₜ≤0.85 (4)
0.05≤S₄₁₁/Sₜₒₜ≤0.80 (5)
S₄₁₁/Sₜᵣₐ≥0.50 (6)
K₄₁₁/K_{tyl}≤0.990 (7)
wherein, in Formula (2), φ represents an angle between a stress vector and a slip direction vector of a crystal and λ represents an angle between a stress vector and a normal vector of a crystal slip plane.

2. A non-oriented electromagnetic steel sheet, comprising:
in percentage by mass,
C: 0.0100% or less;
Si: from 1.50% to 4.00%;
sol.Al: from 0.0001% to 1.0%;
S: 0.0100% or less;
N: 0.0100% or less;
Mn: 0.10% or more;
one kind or a plurality of kinds selected from Mn, Ni, Co, Pt, Pb, Au, or Cu: less than 2.50% in total;
Mo: from 0.0% to less than 2.5%;
Cr: from 0.0% to less than 2.5%;
Ti: from 0.000% to 0.005%;
Nb: from 0.000% to 0.005%;
Sn: from 0.000% to 0.400%;
Sb: from 0.000% to 0.400%;
P: from 0.000% to 0.400%; and
one kind or a plurality of kinds selected from the group consisting of Mg, Ca, Sr, Ba, Ce, La, Nd, Pr, Zn, and Cd: from 0.0000% to 0.0100% in total, wherein:
the non-oriented electromagnetic steel sheet has a chemical composition in which, in a case in which, in percentage by mass, a C content is [C], an Mo content is [Mo], a Cr content is [Cr], an Mn content is [Mn], an Ni content is [Ni], a Cu content is [Cu], an Si content is [Si], a sol.Al content is [sol.Al], and a P content is [P], a transformation temperature Ar₃ (°C) defined by the following Formula (1) is from 750 to 1050 °C and the balance consists of Fe and impurities, and
the following Formula (3) and Formula (4) to Formula (7) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, a total area of an oriented grain in which the Taylor factor M is 2.9 or less is defined as Sₜᵣₐ, an average KAM value of a {411} oriented grain is defined as K₄₁₁, and an average KAM value of an oriented grain in which the Taylor factor M is more than 2.9 is defined as K_{tyl}:
Ar₃ (°C)=1020−325×[C]+33×[Si]+287×[P]+80×[sol.Al]−120×([Mn]+[Mo]+[Cu])−46×([Cr]+[Ni]) (1)
M=(cosφ×cosλ)⁻¹ (2)
S₄₁₁/S₁₀₀>1.00 (3)
0.20≤S_{tyl}/Sₜₒₜ≤0.85 (4)
0.05≤S₄₁₁/Sₜₒₜ≤0.80 (5)
S₄₁₁/Sₜᵣₐ≥0.50 (6)
K₄₁₁/K_{tyl}≤0.990 (7)
wherein, in Formula (2), φ represents an angle between a stress vector and a slip direction vector of a crystal and λ represents an angle between a stress vector and a normal vector of a crystal slip plane.

3. A non-oriented electromagnetic steel sheet, comprising:
in percentage by mass,
C: 0.0100% or less;
Si: from 1.50% to 4.00%;
sol.Al: from 0.0001% to 1.0%;
S: 0.0100% or less;
N: 0.0100% or less;
Mn: 0.10% or more;
one kind or a plurality of kinds selected from Mn, Ni, or Cu: less than 2.50% in total;
Mo: from 0.0% to less than 2.5%;
Cr: from 0.0% to less than 2.5%;
Ti: from 0.000% to 0.005%;
Nb: from 0.000% to 0.005%;
Sn: from 0.000% to 0.400%;
Sb: from 0.000% to 0.400%;
P: from 0.000% to 0.400%; and
one kind or a plurality of kinds selected from the group consisting of Mg, Ca, Sr, Ba, Ce, La, Nd, Pr, Zn, and Cd: from 0.0000% to 0.0100% in total, wherein:
the non-oriented electromagnetic steel sheet has a chemical composition in which, in a case in which, in percentage by mass, a C content is [C], an Mo content is [Mo], a Cr content is [Cr], an Mn content is [Mn], an Ni content is [Ni], a Cu content is [Cu], an Si content is [Si], a sol.Al content is [sol.Al], and a P content is [P], a transformation temperature Ar₃ (°C) defined by the following Formula (1) is from 750 to 1050 °C and the balance consists of Fe and impurities, and
the following Formula (8) to Formula (11) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, and a total area of an oriented grain in which the Taylor factor M is 2.9 or less is defined as Sₜᵣₐ:
Ar₃ (°C)=1020−325×[C]+33×[Si]+287×[P]+80×[sol.Al]−120×([Mn]+[Mo]+[Cu])−46×([Cr]+[Ni]) (1)
M=(cosφ×cosλ)⁻¹ (2)
S₄₁₁/S₁₀₀>2.00 (8)
S_{tyl}/Sₜₒₜ<0.55 (9)
S₄₁₁/Sₜₒₜ>0.30 (10)
S₄₁₁/Sₜᵣₐ≥0.60 (11)
wherein, in Formula (2), φ represents an angle between a stress vector and a slip direction vector of a crystal and λ represents an angle between a stress vector and a normal vector of a crystal slip plane.

4. A non-oriented electromagnetic steel sheet, comprising:
in percentage by mass,
C: 0.0100% or less;
Si: from 1.50% to 4.00%;
sol.Al: from 0.0001% to 1.0%;
S: 0.0100% or less;
N: 0.0100% or less;
Mn: 0.10% or more;
one kind or a plurality of kinds selected from Mn, Ni, Co, Pt, Pb, Au, or Cu: less than 2.50% in total;
Mo: from 0.0% to less than 2.5%;
Cr: from 0.0% to less than 2.5%;
Ti: from 0.000% to 0.005%;
Nb: from 0.000% to 0.005%;
Sn: from 0.000% to 0.400%;
Sb: from 0.000% to 0.400%;
P: from 0.000% to 0.400%; and
one kind or a plurality of kinds selected from the group consisting of Mg, Ca, Sr, Ba, Ce, La, Nd, Pr, Zn, and Cd: from 0.0000% to 0.0100% in total, wherein:
the non-oriented electromagnetic steel sheet has a chemical composition in which, in a case in which, in percentage by mass, a C content is [C], an Mo content is [Mo], a Cr content is [Cr], an Mn content is [Mn], an Ni content is [Ni], a Cu content is [Cu], an Si content is [Si], a sol.Al content is [sol.Al], and a P content is [P], a transformation temperature Ar₃ (°C) defined by the following Formula (1) is from 750 to 1050 °C and the balance consists of Fe and impurities, and
the following Formula (8) to Formula (11) are satisfied in a case in which, in observation on a plane in parallel with a steel sheet surface with EBSD, a total area is defined as Sₜₒₜ, an area of a {411} oriented grain is defined as S₄₁₁, an area of a {100} oriented grain is defined as S₁₀₀, an area of an oriented grain in which a Taylor factor M according to the following Formula (2) is more than 2.9 is defined as S_{tyl}, and a total area of an oriented grain in which the Taylor factor Mis 2.9 or less is defined as Sₜᵣₐ:
Ar₃ (°C)=1020−325×[C]+33×[Si]+287×[P]+80×[sol.Al]−120×([Mn]+[Mo]+[Cu])−46×([Cr]+[Ni]) (1)
M=(cosφ×cosλ)⁻¹ (2)
S₄₁₁/S₁₀₀>2.00 (8)
S_{tyl}/Sₜₒₜ<0.55 (9)
S₄₁₁/Sₜₒₜ>0.30 (10)
S₄₁₁/Sₜᵣₐ≥0.60 (11)
wherein, in Formula (2), φ represents an angle between a stress vector and a slip direction vector of a crystal and λ represents an angle between a stress vector and a normal vector of a crystal slip plane.
